(19) United States
(12) Patent Application Publication
(10) Pub. No.: US 2026/0217928 A1
(43) Pub. Date: Jul. 30, 2026

(54) Guar and Guar-Cellulose Composite Materials

(71) Applicant: Texas Tech University System, Lubbock, TX (US)

(72) Inventors: Noureddine Abidi, Lubbock, TX (US); Sumedha Liyanage, Lubbock, TX (US)

(21) Appl. No.: 19/143,628

(22) PCT Filed: Jan. 2, 2024
(86) PCT No.: PCT/US2024/010036

§ 371 Date: Jun. 26, 2025

Related U.S. Application Data
(60) Provisional application No. 63/478,273, filed on Jan. 3, 2023.

(51) Int. Cl. C08J 5/18; B01J 13/00; B29C 39/26; B29K 1/00; C08J 3/18; C08J 3/24; C08K 3/38; C08K 5/053; C08L 5/14

(52) U.S. Cl. CPC C08J 5/18; B01J 13/0091; B29C 39/26; C08J 3/18; C08J 3/24; C08K 3/38; C08K 5/053; C08L 5/14; B29K 2001/12; B29K 2005/00; C08K 2003/387; C08L 2203/16; C08L 2205/025

(57) ABSTRACT

Provided herein are compositions and methods for making a guar-based composite material comprising: a guar gum comprising 1, 2, 5, 10, 15, 20, 25, 30, 35, 40, or 50% weight to weight of the composite; a cellulose comprising 1, 2, 5, 10, 15, 20, 25, 30, 35, 40, or 50% weight to weight of the composite; and optionally a plasticizer, wherein the composite has a higher flexibility and tensile strength than either the guar gum or cellulose alone

### CROSS-REFERENCE TO RELATED APPLICATIONS

This application claims priority to U.S. Provisional Application Ser. No. 63/478,273, filed Jan. 3, 2023, the entire contents of which are incorporated herein by reference.

### TECHNICAL FIELD OF THE INVENTION

The present invention relates in general to the field of biopolymers, and more particularly, to biopolymer composites made from guar and guar-cellulose.

### STATEMENT OF FEDERALLY FUNDED RESEARCH

None.

### INCORPORATION-BY-REFERENCE OF MATERIALS FILED ON COMPACT DISC

None.

### BACKGROUND OF THE INVENTION

Without limiting the scope of the invention, its background is described in connection with biopolymers.

The dual threat of plastic pollution and the depletion of fossil fuels have increased the interest in biomass-based products that are developed from sustainable and renewable biomass such as plants and marine residues (e.g., cellulose, hemicellulose, chitin, proteins). The magnitude of plastic pollution is vast, and bio-based plastics that are recyclable, compostable, or biodegradable can reduce the carbon footprint as well as the detrimental impacts of synthetic plastics on the environment and human health. As a result, in recent years, there has been an increased interest in biomass-based products that were exclusively made from petrochemical-based materials, which include films, filaments, and porous materials, among others.

Nonfood agroforestry materials (i.e., lignocellulosic feedstock, such as wood and agricultural residue) have been identified as sustainable substitutes for non-renewable petrochemical resources. Lignocellulosic feedstocks have several components, including cellulose, hemicelluloses, and lignin, which play a key role in the production of bio-based materials. Despite the valuable properties and benefits of lignocellulosic biomass, its conversion into bioproducts requires purification and fractionation of the feedstock followed by dissolution, which is considered labor-intensive and involves harsh chemicals.

Despite these advances, what is needed are novel solutions that allow the conversion of plant-based polymers to recyclable, compostable, or biodegradable products for the replacement of non-renewable petrochemical-based products.

### SUMMARY OF THE INVENTION

As embodied and broadly described herein, an aspect of the present disclosure relates to a guar-based composite material comprising: a guar gum comprising 1, 2, 5, 10, 15, 20, 25, 30, 35, 40, or 50% weight to weight of the composite; a cellulose comprising 1, 2, 5, 10, 15, 20, 25, 30, 35, 40, or 50% weight to weight of the composite; and optionally a plasticizer, a crosslinker, or both, wherein the composite has a higher flexibility and tensile strength that either the guar gum or cellulose alone. In one aspect, the composite is a film, aerogel, or filament. In another aspect, the plasticizer is glycerol. In another aspect, the cellulose is at least one of: natural cellulose, microcrystalline cellulose, nanocrystalline cellulose, never dissolved cellulose, methyl cellulose, ethyl cellulose, hydroxyethyl cellulose, hydroxypropyl cellulose, hydroxypropylmethyl cellulose, carboxymethyl cellulose, or cellulose derivatives. In another aspect, the composite is a film comprising at least one of: guar-cellulose films exhibiting smooth surface texture, strain up to about 80% depending on the plasticizer content, tensile strength up to about 95 MPa depending on the type and quantity of cellulose, and smart rolling behavior when exposed to water, alcohol, or acetone. In another aspect, the composite is a film with higher flexibility, elongation, and tensile strength than guar or cellulose alone. In another aspect, the composite is formed into a filament having at least one of: an elongation of up to 180% or a tensile strength of 10, 20, 30, 40, 50, or up to 60 MPa. In another aspect, the composite is formed into an aerogel having a porosity of 80, 86, 90, 95, or 99%. In another aspect, the composite can be dissolved in water and reshaped. In another aspect, the guar gum comprises 1, 2, 5, 10, 15, 20, 25, 30, 35, 40, or 50% weight to weight of the composite. In another aspect, the cellulose comprises 1, 2, 5, 10, 15, 20, 25, 30, 35, 40, or 50% weight to weight of the composite.

As embodied and broadly described herein, an aspect of the present disclosure relates to a method of making a composite comprising: mixing guar gum and cellulose in an aqueous solution into a guar-cellulose mixture; casting guar-cellulose mixture in a mold; drying or freezing the cast guar-cellulose mixture; and freeze-drying the frozen guar-cellulose mixture. In one aspect, the composite is a film, aerogel, or filament. In another aspect, the method further comprises adding a plasticizer, a crosslinker, or both. In another aspect, the cellulose is at least one of: natural cellulose, microcrystalline cellulose, nanocrystalline cellulose, never dissolved cellulose, methyl cellulose, ethyl cellulose, hydroxyethyl cellulose, hydroxypropyl cellulose, hydroxypropylmethyl cellulose, carboxymethyl cellulose, or cellulose derivatives. In another aspect, the composite is a film comprising at least one of: guar-cellulose films exhibiting smooth surface texture, strain up to about 80% depending on the plasticizer content, tensile strength up to about 95 MPa depending on the type and quantity of cellulose, and smart rolling behavior when exposed to water, alcohol, or acetone. In another aspect, the composite is a film with higher flexibility, elongation, and tensile strength than guar or cellulose alone. In another aspect, the composite is formed into a filament having at least one of: an elongation of up to 180% or a tensile strength of 10, 20, 30, 40, 50, or up to 60 MPa. In another aspect, the composite is formed into an aerogel having a porosity of 80, 85, 90, 95, or 99%. In another aspect, the composite can be dissolved in water and reshaped. In another aspect, the guar comprises 1, 2, 5, 10, 15, 20, 25, 30, 35, 40, or 50% weight to weight of the composite. In another aspect, the cellulose comprises 1, 2, 5, 10, 15, 20, 25, 30, 35, 40, or 50% weight to weight of the composite. In another aspect, the method further comprises wet spinning the guar-cellulose mixture into an aqueous acetone-based bath with varying concentrations of a plasticizer to form a filament. In another aspect, the guar gum is gelled in an ionic liquid and the gelled guar gum is regenerated in an organic solvent. In another aspect, the guar-cellulose mixture is mixed with borax to transform never dissolved cotton fibers into flexible paper-like films, wherein the flexible paper-like film is formed without harsh solvents or generating a wastewater with chemical residues.

As embodied and broadly described herein, an aspect of the present disclosure relates to a film, aerogel, or filament comprising: a guar gum comprising 1, 2, 5, 10, 15, 20, 25, 30, 35, 40, or 50% weight to weight of the composite; a cellulose comprising 1, 2, 5, 10, 15, 20, 25, 30, 35, 40, or 50% weight to weight of the composite; and optionally a plasticizer, a crosslinker, or both, wherein the composite has a higher flexibility and tensile strength that either the guar gum or cellulose alone.

### BRIEF DESCRIPTION OF THE DRAWINGS

For a more complete understanding of the features and advantages of the present invention, reference is now made to the detailed description of the invention along with the accompanying figure(s) and in which:

FIG. 1 shows the preparation of guar, guar-microcrystalline cellulose (MCC), and guar-cellulose nanocrystal (CNC) films (RT-Room temperature).

FIGS. 2A and 2B show the temperature-dependent viscosity study of guar-based film-forming solutions. Comparison of temperature-dependent viscosity in film-forming solutions made with varying concentrations of (FIG. 2A) microcrystalline cellulose (MCC) and (FIG. 2B) cellulose nanocrystals (CNC).

FIGS. 3A to 3D are visual images and scanning microscopy micrographs of guar (GG) and guar-based films (left-bottom surface that was in contact with the Petri dish and middle-top surface). (FIG. 3A) Neat guar film, (FIG. 3B) guar film with 30% cellulose nanocrystals (w/w based on the weight of GG), (FIG. 3C) guar film with 30% non-sonicated microcrystalline cellulose (w/w based on the weight of GG), and (FIG. 3D) guar film with 30% sonicated microcrystalline cellulose (w/w based on the weight of GG).

FIGS. 4A to 4D show the optical transmittance of guar-based films. Comparison of optical transmittance of (FIG. 4A) guar and guar-microcrystalline cellulose (MCC) films and (FIG. 4B) guar and guar-cellulose nanocrystal (CNC) films. (FIG. 4C) Optical transmittance of guar, guar-MCC, and guar-CNC films at 600 nm. (FIG. 4D) Transparency of guar films and effect of MCC and CNC on transparency of guar-based films.

FIGS. 5A and 5B show thermogravimetric analysis of guar-based films: first derivative thermogravimetry of (FIG. 5A) neat guar film (GF) and (FIG. 5B) GF, guar-30% microcrystalline cellulose (MCC) (GF-30% MCC), and guar-30% cellulose nanocrystal (CNC) (GF-30% CNC) films.

FIGS. 6A to 6E show tensile properties of guar and guar-based composite films. (FIG. 6A) Representative stress vs. strain curves of neat guar films (Neat-GF) and composite films made with 30% microcrystalline cellulose (G-30% MCC) and 30% cellulose nanocrystal (G-30% CNC). Concentration-dependent changes in (FIG. 6B) tensile strength, (FIG. 6C) percent strain, (FIG. 6D) work to break, and (FIG. 6E) Young's modulus of guar-based films.

FIG. 7 shows the self-rolling behavior of guar films upon repetitive exposure to water and acetone.

FIGS. 8A to 8E show the water contact angle analysis of guar films. (FIG. 8A) Differences in contact angle of water droplets deposited on rough top surface and smooth bottom surface of guar films. Changes in average (FIG. 8B) water contact angle, (FIG. 8C) base area, and (FIG. 8D) drop volume of water droplets deposited on smooth bottom surface and rough top surface of guar films within 2 min. (FIG. 8E) Percent change in water contact angle, base area, and drop volume of water droplets deposited on smooth bottom surface and rough top surface of guar films within 2 min.

FIGS. 9A to 9D show solvent stability tests conducted in water, cooking oil, N,N-dimethylacetamide (DMAc), 10% acetone (v/v), and acetone solution (from left to right, respectively) immediately after immersing in the solution (0 h) and after 3 days (72 h). Solvent stability of (FIG. 9A) neat guar film (GF), (FIG. 9B) guar-30% microcrystalline cellulose (MCC) films, (FIG. 9C) guar-30% cellulose nanocrystal (CNC) films, and (FIG. 9D) guar-30% glycerol films.

FIG. 10 shows a simple and ecofriendly approach for the conversion of low-quality cotton fibers or cotton linters to flexible paper-like films.

FIGS. 11A and 11B show the preparation of guar or guar-cellulose composite filaments by wet spinning of the viscous guar or guar-cellulose solutions to acetone-water bath with varying concentrations of glycerol.

FIG. 12A shows representative stress vs. strain in guar filaments wet spun into water and acetone bath with 0 (0G), 0.5 (0.5G), 1 (1G), 1.5 (1.5G), 2 (2G), and 3% (3G) glycerol. FIGS. 12B, 12C, 12D, and 12E show average strain, tensile strength, work to break, and Young's modulus of guar filaments wet spun to acetone-water bath with varying concentrations of glycerol, respectively.

FIGS. 13A to 13G show the preparation of guar-based porous materials. (FIG. 13A) Preparation steps of guar-based aerogels and produced aerogels of different shapes and sizes. Scanning electron microscopy micrographs of (FIG. 13B) neat guar aerogels frozen at −20° C., (FIG. 13C) neat guar aerogels frozen using liquid nitrogen, and (FIG. 13D) borax crosslinked guar aerogel frozen at −20° C. (FIG. 13E) Borax crosslinked guar aerogels. (FIG. 13F) Foldable and (FIG. 13G) compressible guar aerogels made with low concentrations of guar gum.

FIGS. 14A to 14C show guar-cellulose (microcrystalline cellulose/cotton linter powder) composite aerogels. (FIG. 14A) Preparation steps of guar-cellulose composite aerogels. (FIG. 14B) effect of guar concentration and crosslinking on guar-3% MCC composite aerogels. (FIG. 14C) Scanning electron microscopy micrograph of aerogels made with 1.25% cotton linter powder, 40% guar (w/w based on the weight of cellulose) and 2% borax.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity, but include the general class of which a specific example may be used for illustration. The terminology herein is used to describe specific embodiments of the invention, but their usage does not delimit the invention, except as outlined in the claims.

Provided herein is technology related to the development of guar-based composite materials. Films, aerogels, and filaments were prepared from guar and guar-cellulose aqueous solutions by casting followed by drying, freezing followed by freeze-drying, and wet spinning into acetone-based bath with varying concentrations of glycerol (plasticizer), respectively. The resulting guar-cellulose films exhibited: a smooth surface texture, a strain up to about 60, 70, 75, or 80% depending on the plasticizer content, a tensile strength up to about 60, 70, 75, 80, or 95 MPa depending on the type and quantity of cellulose, and display a smart rolling behavior when exposed to water, alcohol, or acetone. Guar-cellulose filaments show a uniform diameter of approximately 0.2 mm, excellent flexibility, elongation, and tensile strength of 80, 90, 100, 110, 120, 125, 130, or up to 180% and/or 10, 20, 30, 40, 50, or up to 60 MPa, respectively depending on the concentration of the plasticizer. The resulting guar-based porous materials show highly porous structures (porosity of 80, 85, 90, 95, 96, 97, 98, or 99%) and resemble starch-based and polystyrene-based “packaging peanuts”. After use, these bioproducts can be dissolved in water and reshaped as needed.

Cellulose is the most abundant biopolymer on earth and well-known for its abundance, biodegradability, biocompatibility, and renewability. Cellulose has the potential to fulfill the growing demand for bio-based products. Because cellulose cannot be melt-processed and does not dissolve in common organic solvents, its green transformation to products has remained a challenge and is costly. Except for the few “greener” solvents, such as ionic liquids, a number of cellulose solvents have environmental hazards and have limitations and significant deficiencies, such as, longer dissolution times, the need for pretreatment, use of high-temperature conditions, and the high recycling costs of solvents. Currently, the trend is not only towards environmentally friendly materials and renewable sources but also towards environmentally benign techniques and processes that produce virtually no emissions and consume less energy. As a result, while mastering the greener dissolution of cellulose to avoid possible toxic biproducts and the use of hazardous solvents, there is also a trend toward producing bio-based materials via a physical approach and/or with no chemical reactions.

Hemicelluloses are a group of plant cell wall polysaccharides that forms the complex cell wall matrix between cellulose and lignin. Hemicelluloses are among the most abundant biopolymers found on Earth and ranked as the second most abundant polysaccharides in plants. Accounting for a quarter of all plant biomass, similar to cellulose, hemicelluloses are also extracted from lignocellulosic biomass and agricultural residues. However, while cellulose is highly crystalline and shows recalcitrance to dissolution in common solvent systems, hemicelluloses are amorphous polymers and most are easily dissolved in mild aqueous solutions and even in water at acid or alkaline pH. Hemicelluloses, being biocompatible, biodegradable, cost-effective, environmentally friendly, and easily dissolvable in mild aqueous solvents and water, have many potential industrial applications as wound dressing, packaging materials, edible films, drug delivery systems, and tissue engineering, among others.

Galactomannans are a branched heteropolysaccharide with versatile properties, belong to the hemicellulose family and found commonly as the endosperm polysaccharide in family Leguminosae, such as alfalfa (Medicago sativa), fenugreek (Trigonella foenum-graecum), and locust bean (Parkia biglobosa), and also in nonleguminous sources such as coffee (Coffea arabica) and coconut (Cocos nucifera). Galactomannans consist of a linear backbone of (1→4)-linked β-d-mannopyranosyl sugar units with (1→6)-linked α-d-galactopyranosyl sugar side branches. The single unit galactose side branches distribute randomly on the mannose backbone and the galactomannans extracted from different sources show some variability in the mannose to galactose ratio as well as the molecular weight, molecular weight distribution, and the distribution of galactose along the mannose backbone controlling the rate of hydration, solubility, and rheological properties.

Guar gum (GG) is a galactomannan extracted from guar or cluster bean (Cyamopsis tetragonolobus L.), and it is emerging as one of the most versatile and low-cost water-soluble biopolymers with unique fascinating properties. Especially, it is a naturally-derived thickener, binder, and stabilizer that has uses as an additive to pharmaceuticals, food, cosmetics, and several other consumer products. GG is also used to increase the availability of gas and oil through its hydraulic fracking applications. Given the wide range of applications of GG and its utility as a catch crop with excellent tolerance to hot, dry, and saline growing conditions, GG is an extremely important resource for the United States, which is the top consumer of GG in the world.

Owing to the beneficial characteristics, including biodegradability, biocompatibility, nontoxicity, and water solubility, GG and its derivatives are emerging as sustainable raw materials for preparing diverse range of biomaterials, such as superabsorbent water-management materials for agricultural and horticultural applications, agriculture and ecological recovery, and also as a binder and reinforcing filler in different biocomposites. The present inventors recognized that the effective conversion of guar into usable bioproducts does not involve harsh chemicals and sophisticated set up, and requires only simple steps of dissolution in water, conversion into bioproducts through wet spinning, casting followed by drying, or freezing followed by freeze-drying. Among different types of bio-based materials, aerogels (porous materials), films, and filaments play a prominent role in a variety of industrial fields.

Guar-based aerogels. Aerogels have been previously produced using inorganic and plastic-based materials, and have fascinating characteristics of large specific surface area, low bulk density, and high porosity, among other physical properties. Currently, it is a major topic of innovative material research to fabricate bio-derived multifunctional aerogels or polysaccharide aerogels functionally tailored for specific applications in fields as diverse as the pharmaceutical field, biomedical engineering, environmental science, thermal insulator field, and devices used in energy storage, nanotechnology, and biosensing. Some studies reported the development of guar-based porous structure targeting mainly for developing drug delivery systems, thermal insulators, delivery systems with tunable stability, uptake, and release properties, active food packaging and encapsulation of active ingredients/life science applications, metal ions absorption during waste water treatment and devices actuating, carriers of agroinputs such as agriculturally important microbes, pesticides, and fertilizers and also targeting high-performance carbon-based electrocatalysts for energy-related applications. Conversion of galactomannan, galactomannan derivatives, and galactomannan-based polymer mixtures into porous structures can take several routes. Recent literature reported that these porous structures can be developed by casting guar solution in appropriate mold followed by gelation in absolute ethanol or methanol and supercritical drying; freezing and freeze drying; and free radical initiated open air grafting polymerization technique followed by open air oven drying. Water-insoluble aerogels were obtained by enzymatic oxidation pathway of galactomannans followed by freeze drying. Enzymatic crosslinked galactomannan-based aerogels showed a surface area up to 333 m²/g after stepwise solvent exchange followed by supercritical CO₂ drying.

Guar-based films. Bio-based films or membranes are sheet-like flexible materials with tunable morphological and physical properties produced mainly from polysaccharides and proteins. Depending on the starting material, bio-based films are commonly prepared by dissolution followed by casting, gelation, regeneration, and dehydration or casting followed by dehydration. Bio-based films have a wide range of industrial applications ranging from simple packaging material, sensors and conductive materials, ultrafiltration devices, and smart materials to membrane separation. Guar-based films are produced by simple cast-drying approach where a thin layer of guar solution is cast onto a suitable substrate and subsequently dried in ambient temperature conditions or preferably in an oven at lower temperatures. They have found many potential applications as packaging materials (especially as active food and medicinal packaging material) [1]-[7], edible films, wound dressing, biomedical device applications, cell adhesion and drug-delivery systems, sensors, and as conductive materials.

Guar-based filaments. Bio-based fibers, such as rayon, regenerated cellulose fibers fabricated using the viscose process, have been involved in daily life for many decades. The use of bio-based fibrous materials is increasingly becoming popular, especially in the biomedical field due to their mechanical strength, tunability, biocompatibility, porosity, and high-surface area-to-volume ratio. Electrospinning and Wet Spinning/Dry-Jet Wet Spinning are common methods used to create fibers from biopolymers. Guar-based nanofibers/fibers have been prepared by both electrospinning and wet spinning into a coagulating bath of acetone or ethanol. However, the filament prepared by wet spinning of neat GG solutions into an acetone bath produced weak filaments upon drying.

The present invention is directed to producing novel, environmentally friendly bioproducts from GG and using GG as a binder to produce guar-cellulose composite materials.

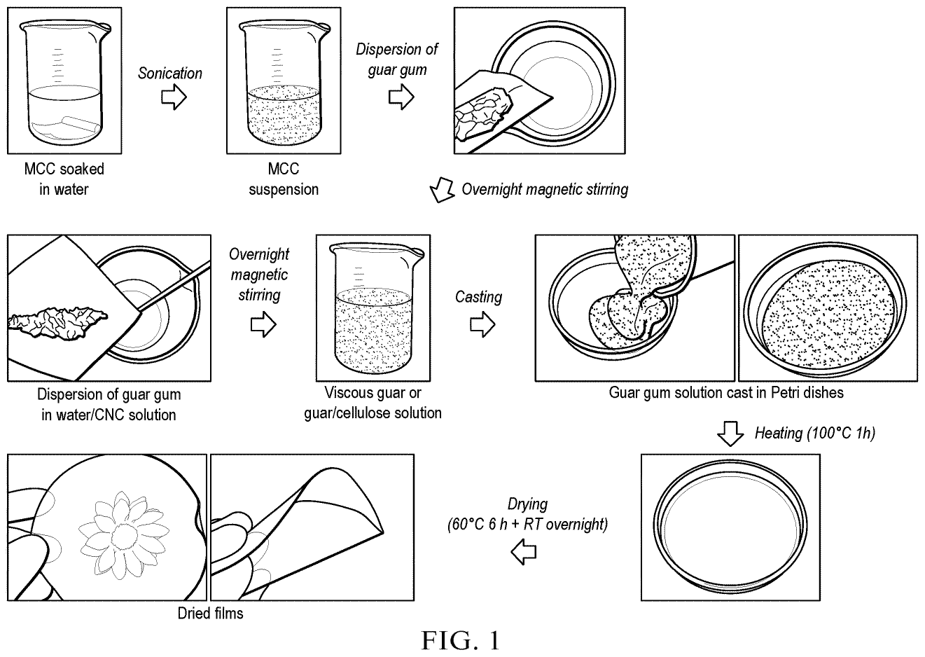

Preparation of guar and guar-cellulose viscous solutions. Guar solution (1.5% w/v) was prepared by slow, gradual dispersion of guar powder (Sigma-Aldrich, St. Louis, MO, USA) in warm distilled water (60° C.) with vigorous mixing followed by magnetic stirring (400 rpm) overnight at room temperature. Similar to many starch-like biopolymers, the preparation of guar-based aqueous solution requires careful control over the dispersion process of the dry guar powder and simultaneous stirring to avoid the formation of polymer aggregates. These aggregates tend to swell during the hydration process and create defects in the final product. Upon complete hydration, the guar mixture appears as a milky gel-like solution, which is shaped into different bioproducts (FIGS. 1, 11, and 13). To prepare plasticized products, glycerol was incorporated (10, 20, and 30% w/w, based on the weight of GG) in water or cellulose suspension immediately before adding GG.

Guar and microcrystalline (MCC) cellulose solutions were prepared by incorporating cotton linter MCC (Sigma-Aldrich, St. Louis, MO, USA) into the solution mixture (10, 20, and 30% w/w, based on the weight of GG). First, cellulose with a required solid concentration was swollen in water overnight and subsequently ultrasonicated for 5 min (Vibra-Cell™ Ultrasonic 500-WATT Liquid Processor, Sonics & Materials Inc., CT, USA) and heated to 60° C. Guar gum powder (1.5% w/v) was gradually dispersed in cellulose water suspension and stirred as discussed.

Cellulose nanocrystals (CNC) were prepared from low-quality cotton linter as reported in a previous study [8]. CNC yield in a given volume of CNC suspension was determined by weighing a 50 ml aliquot of the suspension after freeze drying (FreeZone 4.5 Liter Benchtop Freeze Dry System, Labconco corporation, MO, USA). Guar and CNC solutions were prepared by incorporating 10, 20, and 30% cotton linter CNCs (w/w, based on the weight of GG). First, the desired amount of CNC suspension was mixed with water to obtain the required solid concentration and subsequently heated to 60° C. Then 1.5% w/v guar powder was dispersed in the warm CNC solution and stirred overnight at room temperature.

Guar and guar-cellulose composite films. Preparation of composite films from natural or modified GG involves a few simple steps: (1) gradual dispersion of GG in water, (2) full hydration for several hours with or without continuous stirring, (3) casting and degassing, (4) drying at ambient temperature or preferably in the oven at lower temperatures, and (5) carefully peeling-off films from the container. While in most cases, water, sometimes slightly acidic or basic, is used as the dissolution medium for GG, a few studies also reported on the dissolution of GG in ionic liquid targeting the development of conductive or heat sensitive re-shapeable materials for sensors. In the literature, there are several examples of guar-based film production targeting mostly packaging applications, and Table 1 provides representative examples with their targeted applications.

TABLE 1
Preparation of guar-based films and their targeted applications.

| | | | Targeted | |
|---|---|---|---|---|
| Nr. | Raw material | Preparation method | applications | Ref. |
| 1 | GG | Gelation of GG in ionic liquid 1-butyl-3- | Temperature | [9] |
| | | methylimidazolium chloride (BMIMCl) by | induced shapeable | |
| | | heating cooling process followed by | materials suitable | |
| | | subsequent regeneration in acetone and | for sensors | |
| | | ethanol and compression. | | |
| 2 | Fenugreek gum, GG, | Suspend the gum in BMIMCl and mix with | Bio-based | [10] |
| | locust bean gum | a Polymerizable ionic liquids in methanol. | functional | |
| | | Films were prepared by casting followed by | materials, likely | |
| | | heating at 100° C. for 9 h, keeping at room | conductive | |
| | | temperature for 3 h, Soxhlet extracting in | bioproducts | |
| | | ethanol for 6 h, and drying under reduced | | |
| | | pressure for 2 days. | | |
| 3 | GG, xyloglucan, | Dissolution followed by casting and | N/A | [11] |
| | Chitosan, cellulose | evaporation. | | |
| | microfibril | | | |
| 4 | Chitosan, GG | Dissolution followed by casting and oven | Packaging | [2] |
| | | drying at 50° C. and 50% relative humidity | | |
| | | (RH). | | |
| 5 | Methacryloyl guar | Dissolution followed by casting and drying | N/A | [12] |
| | gum | at 40° C. in a ventilated oven at 30% RH. | | |
| 6 | Purified GG | Dissolution followed by solvent or water | Cell adhesion and | [13] |
| | | evaporation under ambient conditions. | drug delivery | |
| | | | systems | |
| 7 | GG, cotton linter | Disperse CLNFs in distilled water followed | Food and | [3] |
| | nanofibers (CLNFs) | by a known amount of GG at 60° C. Films | pharmaceutical | |
| | | were prepared by casting and drying at | packaging | |
| | | 40° C. for 24 h in a hot air-circulating oven. | | |
| 8 | GG, nanoclay, | Prepare aqueous solutions of GG, nanoclay | Packaging | [4] |
| | glycerol | at various concentration, and 40% glycerol | | |
| | | (w/w of guar) and oven dry at 8 h at 80° C. | | |
| | | Films were subjected to gamma irradiation. | | |
| 9 | Enzymatically | Disperse modified GG in water and add | Edible films | [14] |
| | modified GG, locust | glycerol or sorbitol solution (80° C.), | | |
| | bean gum, glycerol, | homogenize, degas by ultrasonication under | | |
| | sorbitol | vacuum, and dehydrate by casting method | | |
| | | at 60° C. | | |
| 10 | GG, silver | Prepare films by casting 40 ml of guar | Textiles, | [15] |
| | nanoparticle | silver nanoparticle solution followed by | packaging, and | |
| | | water evaporation at 60° C. for 24 h. | biomedical device | |
| | | | applications | |
| 11 | TOCNs, | Prepare 1% CMG or HPG solutions with | Food or medicine | [5] |
| | carboxymethyl guar | constant stirring for 8 h and subsequently | packaging | |
| | (CMG), | mixing with TOCNs. Films were prepared | | |
| | Hydroxypropyl guar | by cast-drying of FFS at 50° C. for 3 days. | | |
| | (HPG) | | | |
| 12 | GG, Nano-alumina | Prepare solutions by dispersing GG in | Food and | [6] |
| | | water with varying concentrations of nano- | pharmaceutical | |
| | | alumina. Films were prepared by casting | packaging | |
| | | and oven drying of FFS at 40° C. for 24 h. | | |
| 13 | GG, soy protein | Disperse SPI in deionized water and | Packaging | [16] |
| | isolate (SPI), | absolute ethyl alcohol (4:1 (v/v)) and add | applications | |
| | glycerol | glycerol and different concentrations of | | |
| | | GG. Films were prepared by defoaming, | | |
| | | casting, and natural drying of FFS. | | |
| 14 | GG, silver-copper | FFS was made by dispersing GG and | Active food | [1] |
| | alloy nanoparticles | glycerol in Ag—Cu NPs suspensions | packaging material | |
| | (Ag—Cu NPs) | followed by sonication, stirring, and | | |
| | | degassing. Films were prepared by casting | | |
| | | followed by oven drying of FFS at 80° C. for | | |
| | | 8 h. | | |
| 15 | Cationic GG (CGG), | Films were prepared by layer-by- layer | Green packaging | [17] |
| | TOCNs | casting of CGG and TOCNs solutions and | material or as a | |
| | | oven drying it at 60° C. | platform for | |
| | | | functional materials | |
| 16 | Nanocrystalline | Prepare FFS by mixing and stirring GG | Food packaging | [7] |
| | cellulose (NCC), | aqueous solution, CH solution (1%, w/v), | | |
| | chitosan (CH), GG | and different concentrations of NCC | | |
| | | suspension in that order. Films were | | |
| | | prepared by homogenization followed by | | |
| | | casting and drying (50° C. for 5 h) of FFS. | | |
| 17 | Potato starch, GG, | FFS was prepared by dissolving GG and | Packaging | [18] |
| | glycerol | potato starch in certain proportion in water | | |
| | | followed by adding glycerol and | | |
| | | gelatinization at 90° C. Films were prepared | | |
| | | by degassing of FFS followed by casting | | |
| | | and drying at 37° C. for 24 h. | | |
| 18 | CNF, different forms | Film forming gel was prepared by adding | Packaging and | [19] |
| | of modified GG | modified GG to CNF gel. Films were | medical | |
| | (partially hydrolyzed, | prepared by wet-pressing followed by hot- | applications | |
| | and oxidized GG) | pressing. | | |
| 19 | Sago starch, GG, | FFSs were prepared by mixing 2.5% (w/w) | Prophylaxis of the | [20] |
| | whey protein isolate | sago starch, 0.2% (w/w) of GG and 0.75% | bacterial | |
| | (WPI), glycerol, | (w/w) of WPI dispersions in different | gastroenteritis. | |
| | essential oils | proportions and 40% (w/w) glycerol. | | |
| | | Essential oils were incorporated by | | |
| | | homogenization. Films were prepared by | | |
| | | casting and drying at 40° C. for 48 h. | | |
| 20 | Purified (PGG) and | FFS was prepared by mixing 1% GG | Packaging | [21] |
| | Methylated (MGG) | aqueous solution (PGG and MGG in | | |
| | GG | different ratios) and 40% (w/w GG). | | |
| | | glycerol. Films were prepared by casting | | |
| | | and drying approach. | | |
| 21 | GG | FFS was made by mixing different | Packaging | [22] |
| | | concentrations of GG in 1M HCl solution. | materials | |
| | | Films were prepared by casting followed by | | |
| | | ambient temperature drying. | | |
| 22 | GG, sodium | FFSs were prepared by dissolving SC and | Food packaging | [23] |
| | caseinate (SC), TiO₂, | different concentrations of GG, TiO₂, and | and wound dressing | |
| | cumin essential oil | CEO followed by ultrasonication or | materials | |
| | (CEO) | homogenization. Films were prepared by | | |
| | | casting followed by vacuum drying at 30 ± | | |
| | | 1° C. and 50 ± 6% RH for 24 h. | | |

GG = Guar gum
FFS = Film-forming solution
TOCNs = TEMPO-oxidized cellulose nanofibrils

Provided herein is a technology related to the development of guar-based films. In the first example, neat guar and guar-cellulose composite films were prepared using a simple approach, and the resulting films are smooth, transparent, strong, flexible, and show strains up to 80% depending on the level of plasticization. Compared to reported literature that targets packaging applications, these guar-based films stand out due to their smart rolling behavior upon multiple exposures to water and acetone/antisolvents. In the second example, guar and borax were used to transform never dissolved cotton fibers into flexible paper-like films that could avoid the use of harsh solvents and the generation of wastewater with chemical residues.

### Example 1: Preparation of Guar and Guar-Cellulose Composite Films

The preparation steps of guar and guar-cellulose composite films by the cast-drying approach of the film-forming solutions (FFS) are given in FIG. 1. The obtained gel-like guar, guar-glycerol, guar-MCC, and guar-CNC solutions were cast in glass Petri dishes, covered with aluminum foil, and subsequently transferred to 100° C. oven. After 1 h, samples were uncovered, and air bubbles were removed by gentle tapping of Petri dishes on a flat surface. Then guar solutions were oven-dried at 60° C. for 6 h and further conditioned at room temperature overnight. The resultant films were carefully peeled off from Petri dishes.

FIG. 1: Preparation of guar, guar-microcrystalline cellulose (MCC), and guar-cellulose nanocrystals (CNC) films (RT-Room temperature).

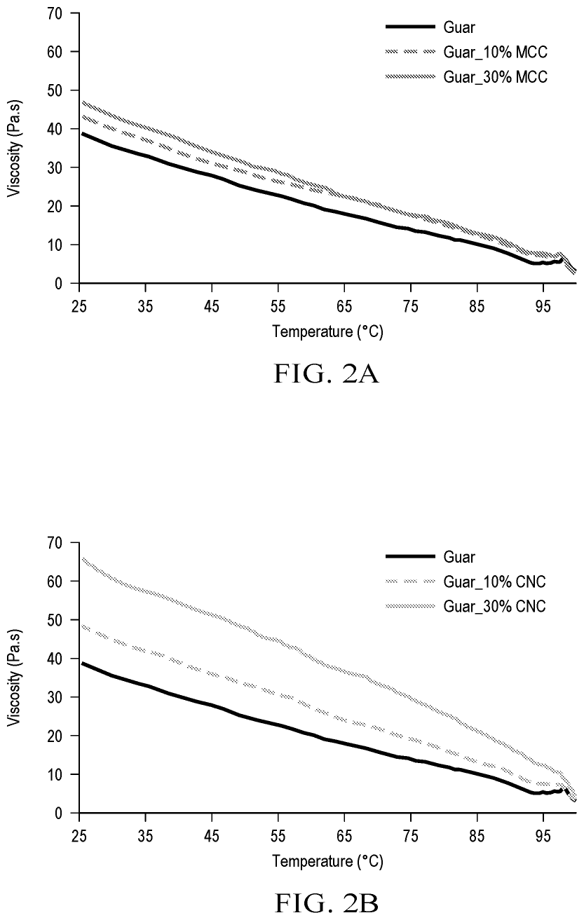

Preparation of bioplastic films from colloidal suspensions via casting is a well-known process. In general, the FFS are degassed and subsequently cast in glass or Teflon containers. However, the high viscosity of 1.5% w/v guar solutions reduces the movement of air bubbles and flowability of the solutions, which affects the degassing process and the uniformity of the resulting films, respectively. From FIGS. 2A and 2B, it is apparent that the addition of cellulose, especially CNC, increases the viscosity of the solution in a concentration-dependent manner, which reduces the flowability of FFS and the ability to remove entrapped air bubbles. The increase in temperature leads to an increase in the kinetic energy and mobility of molecules. Since the temperature reduces the cohesive forces between molecules that keep the molecules closer together (higher viscosity), the viscosity of the solutions reduces as a function of temperature increase. Therefore, guar-based FFS cast in Petri dishes were heated in 100° C. oven for 1 h, during which the solutions become less viscous (FIGS. 2A and 2B) facilitating the movement of air bubbles and resulting in a uniform layer of solution that converts into uniform films. It was noticed that the increase in CNC concentration to 30% (w/w based on the weight of GG) caused approximately 66% increase in viscosity at room temperature and consequently interfered with the degassing process. Air bubbles can also be removed by centrifugation, ultrasonication under a vacuum, or by keeping under a vacuum, which may take a relatively a long period of time given the viscous nature of the guar gel, especially the gels made with 20 and 30% cotton CNC. Guar and CNC are both hydrophilic molecules with very good compatibility and hence have a strong molecular attraction that could lead to an increase in viscosity in a concentration-dependent manner [3].

FIGS. 2A and 2B show the temperature dependent viscosity study of guar-based film-forming solutions. Comparison of temperature dependent viscosity in film-forming solutions made with varying concentrations of (FIG. 2A) microcrystalline cellulose (MCC) and (FIG. 2B) cellulose nanocrystals (CNC).

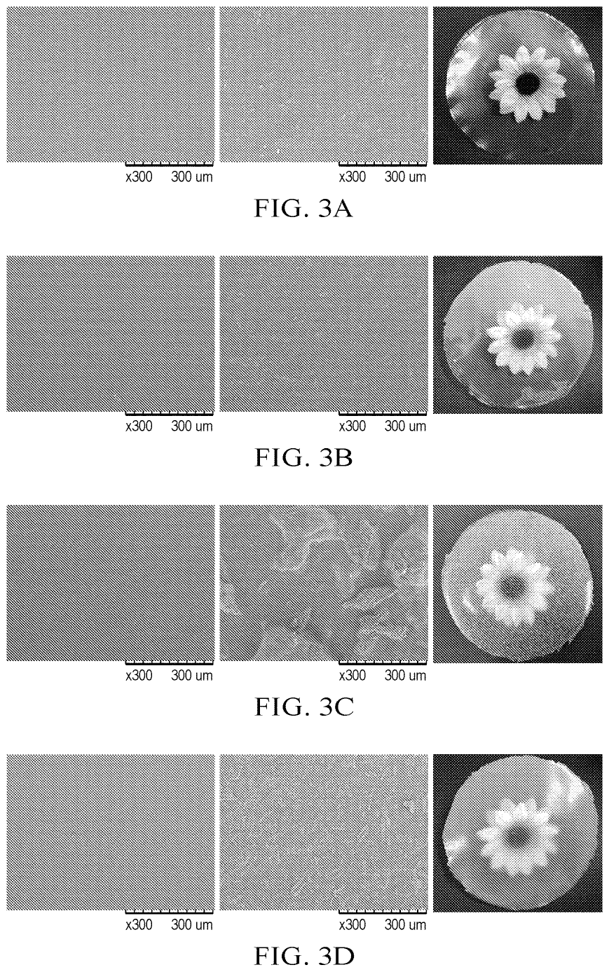

Guar and guar-cellulose films show highly flexible, strong, smooth, and uniform structures with thicknesses ranging from 50-70 μm. FIGS. 3A to 3D demonstrates that the surface structure of guar-based films, especially the top surface, changes upon the addition of MCC. Guar-MCC films made with non-sonicated MCC show a granular and uneven structure with masses of MCC which could be visually noticed. The sonication process breaks down these pieces, and the top surface of guar-MCC films made with sonicated MCC shows relatively small pieces of MCC. All guar and guar-cellulose composite films show a very smooth and shiny bottom surface that was in contact with Petri dishes irrespective of the quantity and type of cellulose. Guar and guar-CNC films show similar surface morphology on both top and bottom surfaces.

FIGS. 3A to 3D are visual images and scanning microscopy micrographs of guar and guar-based films (left-bottom surface that was in contact with the Petri dish and middle-top surface). (FIG. 3A) Neat guar film, (FIG. 3B) guar film with 30% cellulose nanocrystals (w/w based on the weight of GG), (FIG. 3C) guar film with 30% non-sonicated microcrystalline cellulose (w/w based on the weight of GG), and (FIG. 3D) guar film with 30% sonicated microcrystalline cellulose (w/w based on the weight of GG).

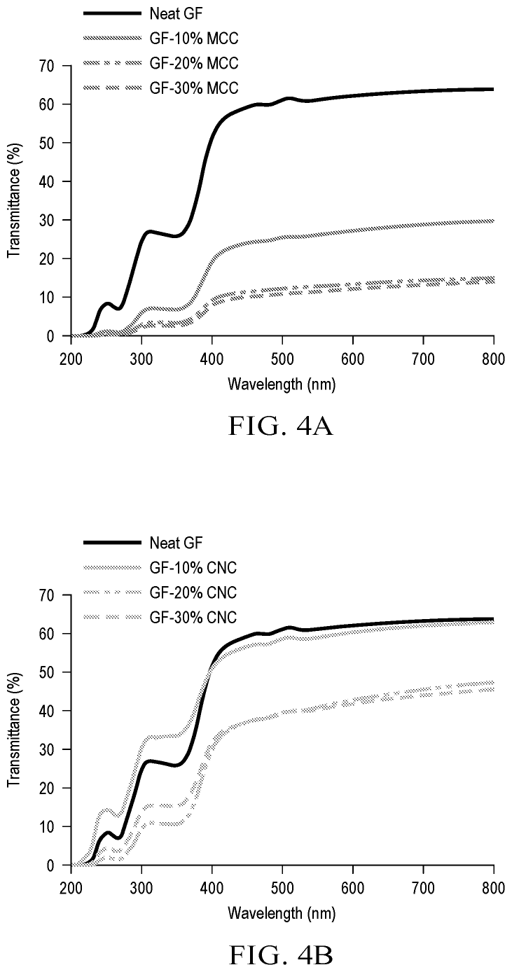

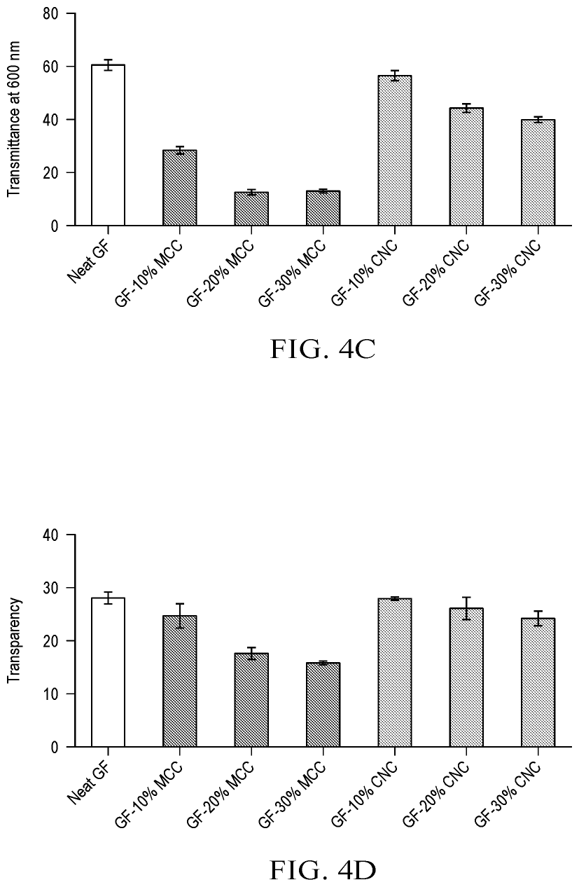

Neat guar films show excellent transparency, which could be further improved if purification was conducted prior to the dissolution process. The addition of cellulose in varied proportions, especially MCC, leads to a decrease in the transparency of the films. FIGS. 4A to 4D show optical transmittance data collected from guar and guar-based films measured between 200 to 800 nm using UV-vis spectrophotometer and their transparency that was calculated using the following equation,

$$Transparency = \frac{Log {T}_{600}}{D}$$

where, T₆₀₀ is the percent transmittance at 600 nm and D is the thickness of the film (mm). The incorporation of CNC does not cause major changes in film transparency (FIG. 4D). The slight reduction in transparency in guar-CNC composite films as a function of CNC concentration is attributed to the formation of CNC aggregates leading to light scattering. The transparency of guar-based films shows a significant reduction due to the incorporation of MCC, especially at 20 and 30% (w/w based on the weight of GG) possibly due to light scattering by MCC aggregates.

FIGS. 4A to 4D show the optical transmittance of guar-based films. Comparison of optical transmittance of (FIG. 4A) guar and guar-microcrystalline cellulose (MCC) films and (FIG. 4B) guar and guar-cellulose nanocrystal (CNC) films. (FIG. 4C) Optical transmittance of guar, guar-MCC, and guar-CNC films at 600 nm. (FIG. 4D) Transparency of guar films and effect of MCC and CNC on transparency of guar-based films.

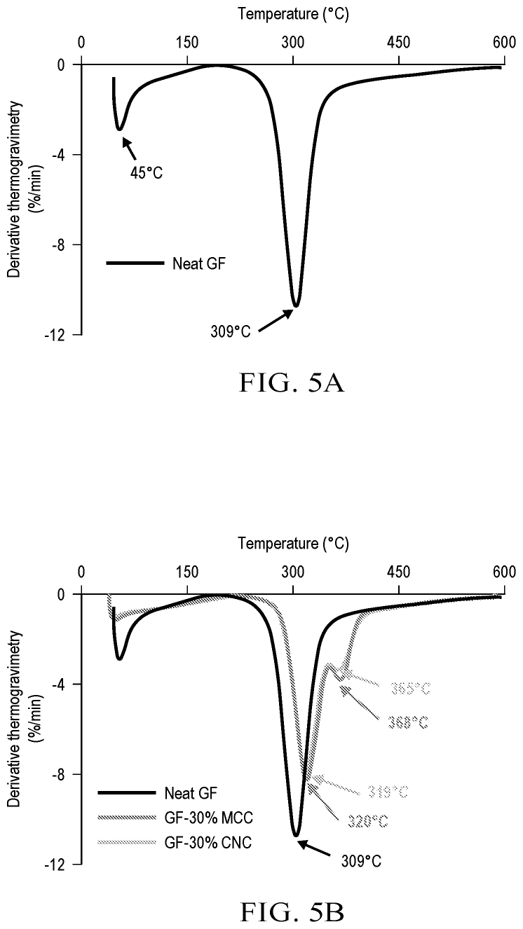

The TGA thermograms of guar films were identical to those of GG having two main weight loss regions attributed to the removal of adsorbed water (~45° C.) and decomposition of galactomannan (~309° C.) (FIGS. 5A to 5B). Incorporation of both MCC and CNC increased the decomposition temperature of galactomannan by about 10° C. The thermal stability of these neat guar, guar-MCC, and guar-CNC films are much better than neat carboxymethyl guar (281° C.), carboxymethyl guar-TEMPO-oxidized cellulose nanofiber (TOCN) (276° C.), Hydroxypropyl guar (270° C.), and Hydroxypropyl guar-TOCN (258° C.) films. In addition to these two weight loss regions that were attributed to the removal of adsorbed water and decomposition of galactomannan, guar-MCC and guar-CNC composite films showed an additional weight loss region peaked at around 365° C. which is attributed to the decomposition of cellulose.

FIGS. 5A and 5B show thermogravimetric analysis of guar-based films: first derivative thermogravimetry of (FIG. 5A) neat guar film (GF) and (FIG. 5B) GF, guar-30% microcrystalline cellulose (MCC) (GF-30% MCC), and guar-30% cellulose nanocrystal (CNC) (GF-30% CNC) films.

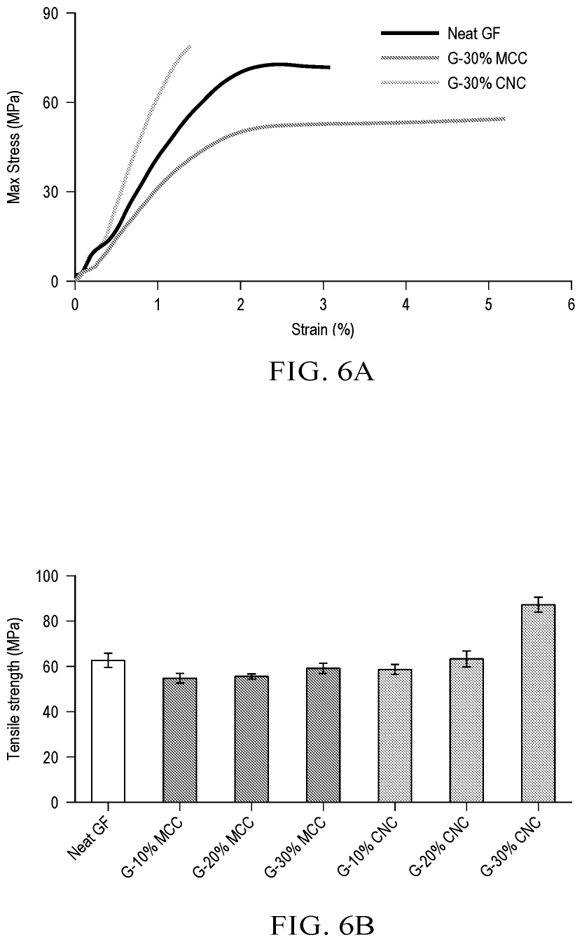

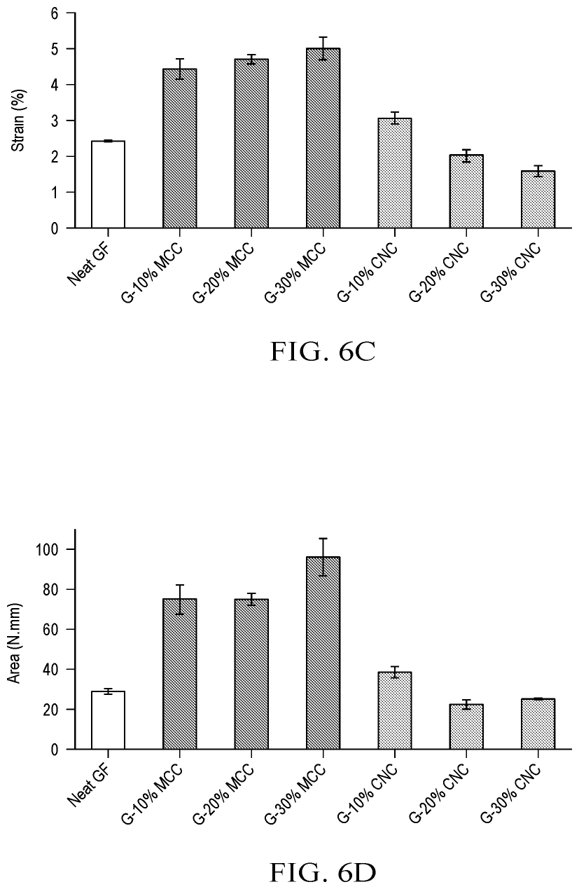

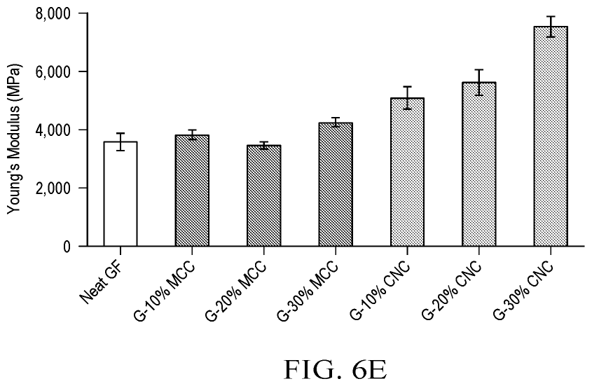

FIGS. 6A to 6E show representative stress vs. strain curves of guar, guar-MCC, and guar-CNC composite films, and concentration-dependent change in tensile strength, strain, work to break (area under load vs displacement curve), and Young's modulus of these films. The average tensile strength, strain, work to break, and Young's modulus of neat guar films are approximately 62.7±4.5 MPa, 2.6±0.1%, 44.0±7.5 N·mm, and 4.7±0.6 GPa, respectively. The incorporation of MCC and CNC shows changes in some of these properties in a concentration-dependent manner.

The average tensile strength of guar films shows a significant increase with the addition of 30% CNC (87.4±2.1 MPa). Dai et al., also reported a pronounced increase in tensile strength of carboxymethyl and hydroxypropyl guar films with the addition of 30% TOCNs due to the reinforcing effect of CNC, especially at higher weight ratios [17]. However, incorporation of 10, 20, and 30% MCC or 10 and 20% of CNC does not lead to a significant improvement in tensile strength. It has been reported that polymers with a high affinity to water increase the water plasticization effect of composites at higher RH values which could be responsible for the increase in percent strain of guar-MCC composite films rather than reinforcing them. In fact, the incorporation of MCC, irrespective of the concentration, and 10% CNC shows a significant increase in % strain of guar-based films. However, a further increase in CNC concentration significantly reduced the % strain of guar-based films. Furthermore, guar-MCC films show a significantly higher work to break compared to those of neat guar films and guar-CNC composite films and no major change in work to break is noticeable due to changes in MCC concentration up to 30%. Guar-CNC composite films do not show a major change in work to break compared to neat guar films. The incorporation of MCC does not contribute to a significant increase in film stiffness as indicated by Young's modulus. Films made with 10 and 20% of CNC show a significantly higher Young's modulus and a further increase in CNC concentration up to 30% also leads to a significant increase in Young's modulus (7.5±0.3 GPa).

FIGS. 6A to 6E show tensile properties of guar and guar-based composite films. (FIG. 6A) Representative stress vs. strain curves of guar neat guar films (Neat-GF) and composite films made with 30% microcrystalline cellulose (G-30% MCC) and 30% cellulose nanocrystal (G-30% CNC). Concentration-dependent changes in (FIG. 6B) tensile strength, (FIG. 6C) percent strain, (FIG. 6D) work to break, and (FIG. 6E) Young's modulus of guar-based films.

The percent strain of these guar-based films ranges approximately between 1-5% and plasticization increased the percent strain to 70-80% depending on the concentration of the plasticizer. However, Saurabha et al., reported approximately 16-22% elongation in the guar-based nanocomposite films that were prepared with 40% glycerol [4]. The average work to break of guar films that were plasticized with 30% glycerol was approximately 163 N·mm. The tensile strength and stiffness of glycerol plasticized guar films show a significant reduction in a concentration-dependent manner which leads to approximately 76% reduction in tensile strength and over 99% loss in Young's Modulus with the addition of 30% glycerol.

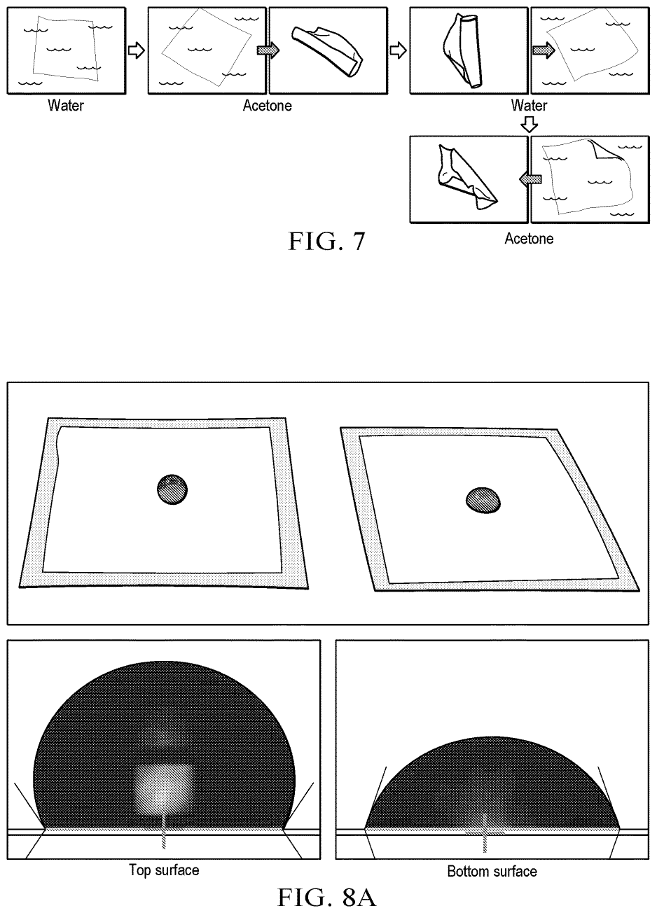

The dry guar-based films show reversible self-rolling or reshaping behavior when they are repetitively exposed to water (or aqueous solutions) and other solvents with high affinity to water, such as acetone (FIG. 7). For example, when a dry guar film is immersed in water, the film immediately starts to roll from the sides. If the film is taken out of the water and immediately immersed in acetone, it opens up (unfolds) and starts to roll again. Re-immersing the films in water opens them (unfolds) and transferring to acetone makes them fold/roll again. This phenomenon repeats many times without disintegrating the film and emersion in acetone makes the film stiffer while immersing in water makes it flexible.

FIG. 7 shows the self-rolling behavior of guar films upon repetitive exposure to water and acetone.

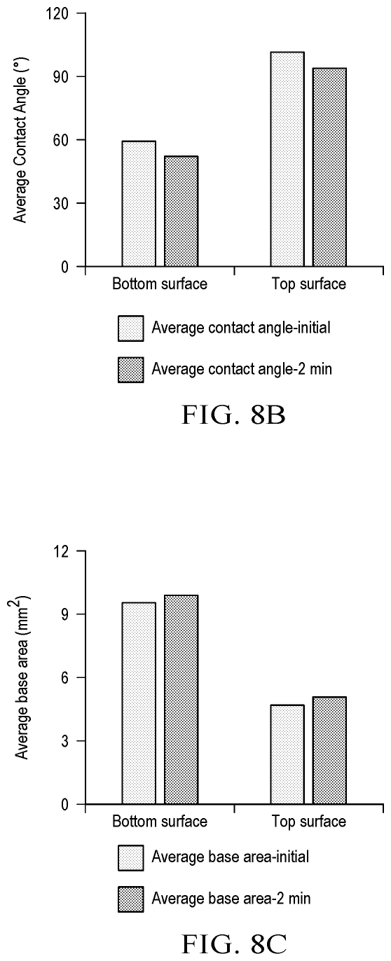

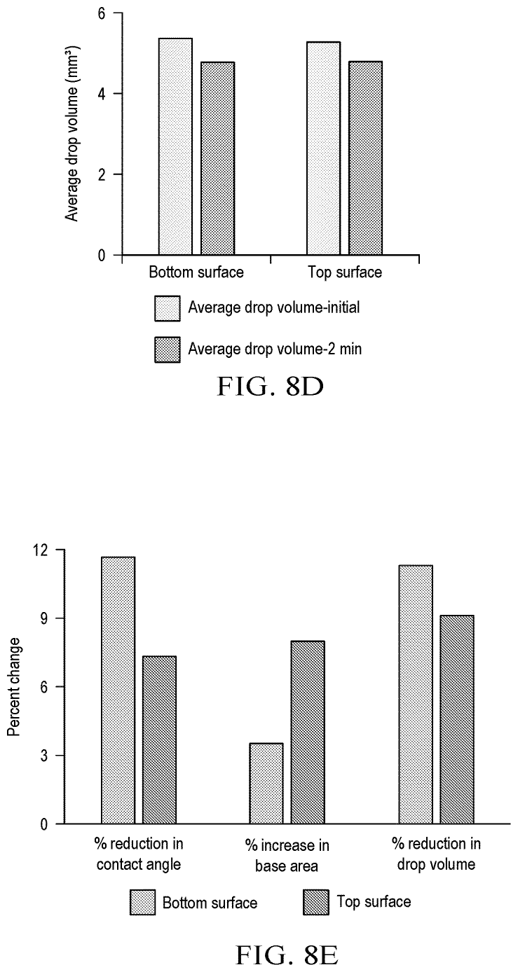

FIGS. 8A to 8E show the dynamic water contact angles of the top rough and bottom smooth surfaces of neat guar films. Water droplets deposited on the top and bottom surfaces of the guar film show an average contact angle of approximately 101.4±3.3° and 59.6±4.6°, respectively. Because microscopic roughness features create hydrophobicity, this significant difference in water contact angle could be attributed to differences in surface roughness of guar films. As shown in FIG. 3, the bottom surface of guar films that was in contact with the Petri dish during the preparation process shows a very smooth surface structure while the surface that was exposed to outside air shows a rough surface structure. Even though guar is a water-soluble polymer, the roughness of the top surface makes it hydrophobic and the smoothness of the bottom surface makes it retain the hydrophilic nature of GG (FIG. 8A). The base area of the water droplet that touches the films was significantly larger in the smooth bottom side, indicating the spreading of water droplet compared to that of the rough top surface.

The water droplets were allowed to stand on the film surface, undisturbed, and the drop characteristics were remeasured after 2 min (FIG. 8B-D). As shown in FIG. 8E, the average contact angle and drop volume of the water droplets that were deposited on the smooth surface show approximately 12% and 11% reduction after 2 min, respectively, while the droplets that were deposited on the rough surface show approximately 7 and 9% reduction in contact angle and drop volume, in that order. The reduction in drop volume indicates that water is adsorbed into guar films. Furthermore, according to the changes in base area of the water droplets that were deposited on both surfaces, it seems that water spreads faster on the top rough surface (% increase in base area is ~8%) compared to the smooth side (% increase in base area is ~3.5%).

Accordingly, the reduction in water contact angle on the top rough surface is mainly attributed to the spreading of water and on the bottom smooth surface is mostly due to the adsorption of water. Differences in surface structures of two surfaces that control their interaction with water could be the leading cause of the reversible self-rolling behavior of guar films when they are repetitively exposed to water and solvents with high affinity to water, such as acetone, which removes water from the sample.

FIGS. 8A to 8E show the water contact angle analysis of guar films. (FIG. 8A) Differences in contact angle of water droplets deposited on rough top surface and smooth bottom surface of guar films. Changes in the average (FIG. 8B) water contact angle, (FIG. 8C) base area, and (FIG. 8D) drop volume of water droplets deposited on smooth bottom surface and rough top surface of guar films within 2 min. (FIG. 8E) Percent change in water contact angle, base area, and drop volume of water droplets deposited on smooth bottom surface and rough top surface of guar films within 2 min.

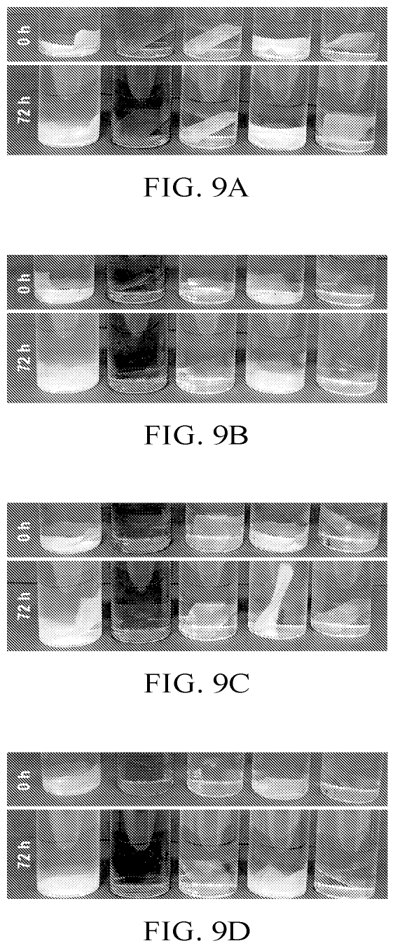

According to solvent stability tests conducted in various solvents (FIG. 9), the guar-based films show no visible changes when immersed in organic polar solvents such as N,N-dimethylacetamide (DMAc) and acetone, as well as in cooking oil. However, when exposed to water and a diluted aqueous solution of acetone (10% v/v), all the films exhibit some degree of swelling, with distinct variations observed among the different film types. The neat guar film and films with 30% glycerol displayed the fastest swelling behavior in water. Especially, a cloudy layer was formed in water adjacent to films within 3 h of the experiment, indicating a gradual disintegration of the polymers from the films (FIGS. 9A and 9D). In the case of films with 30% CNC and MCC, water became slightly cloudy over a three-day period (FIGS. 9B and 9C). Additionally, it was observed that neat guar films and films with 30% MCC and glycerol adhered to the bottom of sample containers and broke into pieces when agitated.

The presence of organic polar solvents, even at lower concentrations such as 10% (v/v), appears to slow down the dissolution process of guar-based films. The 10% acetone solutions with neat guar films and films with 30% glycerol exhibited less cloudiness compared to those in distilled water. The 10% acetone solution with guar-cellulose composite films did not exhibit any cloudiness even after 3 days. In contrast to all the types of films, films with 30% CNC behaved differently when immersed in water and 10% acetone solution. The guar-CNC film immersed in water appeared folded and swollen but retained its shape without sticking to the container. Interestingly, the guar-CNC film in the 10% acetone solution initially appeared folded and swollen but gradually unfolded and formed a free-standing gel (FIG. 9C). This gel maintained its shape for several months. Nanocellulose networks undergo partial hornification during film drying, resulting in a strong network that provides solvent resistance [24]. This phenomenon may explain the formation of self-standing gels in guar-based films containing 30% CNC.

FIGS. 9A to 9D show solvent stability tests conducted in water, cooking oil, N,N-dimethylacetamide (DMAc), 10% acetone (v/v), and acetone solution (from left to right, respectively) immediately after immersing in the solution (0 h) and after 3 days (72 h). Solvent stability of (FIG. 9A) neat guar film (GF), (FIG. 9B) guar-30% microcrystalline cellulose (MCC) films, (FIG. 9C) guar-30% cellulose nanocrystal (CNC) films, and (FIG. 9D) guar-30% glycerol films.

### Example 2: A Solvent Free Approach to Convert Cotton Linters to Flexible Films Using Guar Gum

In this example, guar was used as a binder for converting cotton linters or low-quality cotton that lacks textile value to flexible paper-like films. Cotton linters are the part of cotton fibers that remain on the seeds after the ginning process that removes long fibers from seeds. Low-quality cotton is a common problem in cotton grown around the globe due to management practices and commonly due to recurring extreme weather events. They can be converted to usable bioproducts via dissolution followed by casting, gelation, regeneration, and hot pressing; wet or dry spinning; 3D printing; gelation, regeneration, solvent exchange, and supercritical drying; and gelation, regeneration, freezing followed by freeze-drying. These processes in general require expensive solvents, harsh chemicals that could have environmental hazards, a lot of water for the regeneration process to remove the solvents, and lengthy and energy-consuming dissolution procedures among other problems. The inventors developed a simple and chemical-free process to convert cotton linters or low-quality cotton to produce paper-like films.

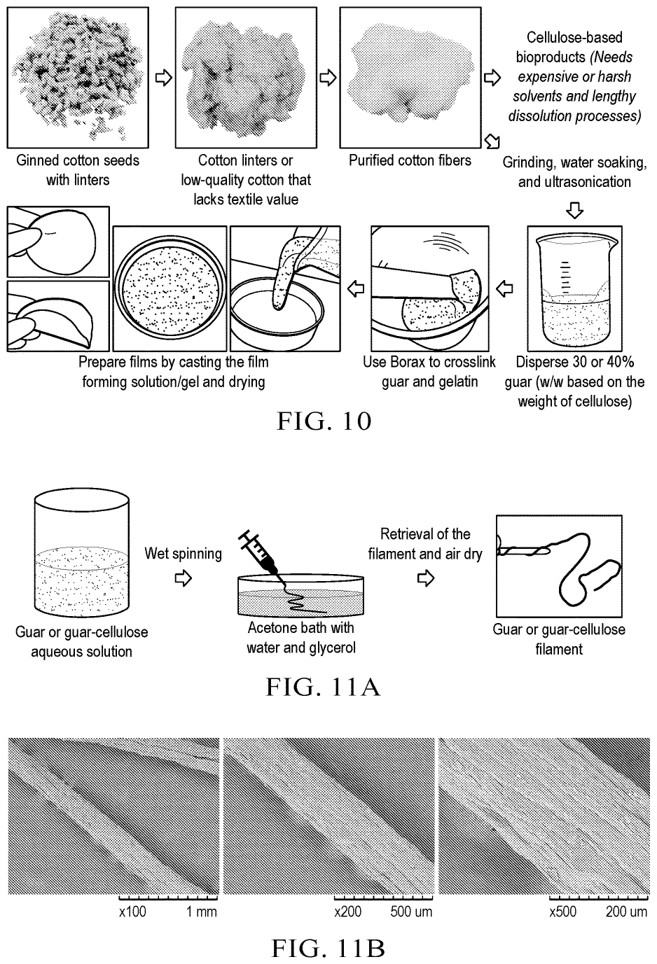

Purified cotton linters were ground to 40 mesh size using a laboratory mill and soaked in water overnight (1.25% w/v). Then, the linter powder was ultrasonicated for 15 min and 10, 20, 30, and 40% GG (w/w based on the weight of cotton linter) was dispersed to make a viscous solution to properly disperse linter powder in solution. However, 10 and 20% of GG did not produce a viscous enough solution to keep the linter powder uniformly dispersed in the solution. As a result, cotton linter fragments settled down at the bottom of the containers within a shorter period of time. Therefore, 30 and 40% guar powder was used for further investigations. Cotton linter and guar mixture was magnetically stirred for 6 h and 2% of borax (a common crosslinker used for guar gum, w/w based on the dry weight the solution) was added to the solution with vigorous stirring with a glass rod. The solution, which immediately become viscous, was allowed to gelate for 24 h. Then, 25 ml of the FFS or the gel was cast in Petri dishes, allowed to dry at room temperature inside a fume hood, and carefully peeled off from the Petri dishes. The dried cotton linter-guar films show a smooth and uniform structure with great flexibility (FIG. 10).

FIG. 10 shows a simple and ecofriendly approach for the conversion of low-quality cotton fibers or cotton linters to flexible paper-like films.

Guar and guar-based composite filaments. Guar nanofibers/fibers have been prepared by electrospinning of guar or guar blends and even by wet spinning GG blends into an antisolvent, such as acetone or ethanol. In two studies, GG was directly spun into an acetone bath and also GG was used as a carrier component in coaxial spinning to successfully prepare CNF filaments (CNF-core and GG as the outer shell component). The authors reported [25], that the filament prepared by wet spinning neat GG solutions into an acetone bath produced weak filaments that could not even be used for tensile measurements in the dry state [26]. However, to the best of the inventors' knowledge, guar filaments or fibers have not been wet spun into acetone-water-glycerol medium to produce uniform thin filaments with remarkable strength and elongation that depend on the concentrations of glycerol in the coagulation bath.

Several studies reported on the guar-based filaments or rather fibrous mats targeting mostly food and tissue engineering applications. Table 2 provides representative examples with their targeted applications.

TABLE 2
Preparation of guar-based filaments and their targeted applications

| Nr. | Raw material | Preparation method | Targeted applications | Ref. |
|---|---|---|---|---|
| 1 | CNFs, GG, | Wet spinning of GG into a coagulation bath | Possibly for absorbance | [25] |
| | cellulose acetate | of acetone and coaxial wet spinning (core- | applications | |
| | (CA) | shell spinning - CNF core and GG shell) | | |
| | | into acetone or ethanol coagulation bath. | | |
| 2 | CNFs, GG, CA | Coaxial wet spinning of CNF into an | NA | [26] |
| | | antisolvent bath (GG- acetone and CA- | | |
| | | water) where CA and GG were used as the | | |
| | | shell or carrier component to stop filament | | |
| | | breakup during spinning. | | |
| 3 | GG of two | Electrospinning of aqueous solutions of | 3D loose mat that mimic | [27] |
| | different | commercial GG, purified GG and filtered | extra cellular matrix for | |
| | commercial | GG at different concentrations on mica and | regenerative medicine | |
| | sources | copper tapes. | | |
| 4 | GG and corn | Electrospinning of aqueous solutions of GG | Fibers and fibrous mats | [28] |
| | starch | and corn starch solutions with different | for food-grade | |
| | | mass ratios on a rotating drum covered with | applications | |
| | | non-sticky aluminum foil. | | |
| 5 | GG blends of | Electrospinning blends of purified native | Targeting filtration, | [29] |
| | different | high molecular weight GG and its | drug delivery, tissue | |
| | molecular | hydrolyzed low molecular weight GG. | engineering, and wound | |
| | weight | | dressing applications | |

Provided herein is a technology related to the development of guar-based filaments by wet spinning into an acetone-based coagulation bath with varying concentrations of a plasticizer. The resulting filaments are smooth, strong, flexible, and show a remarkable strain of up to 140% depending on the level of plasticization. Compared to reported literature that targets the production of guar base fibrous mat or using guar gum as a shell or carrier component to stop filament breakup during coaxial wet spinning, these guar-based filaments stand out due to their remarkable strain in their dry state.

### Example 3: Preparation of Guar Filaments

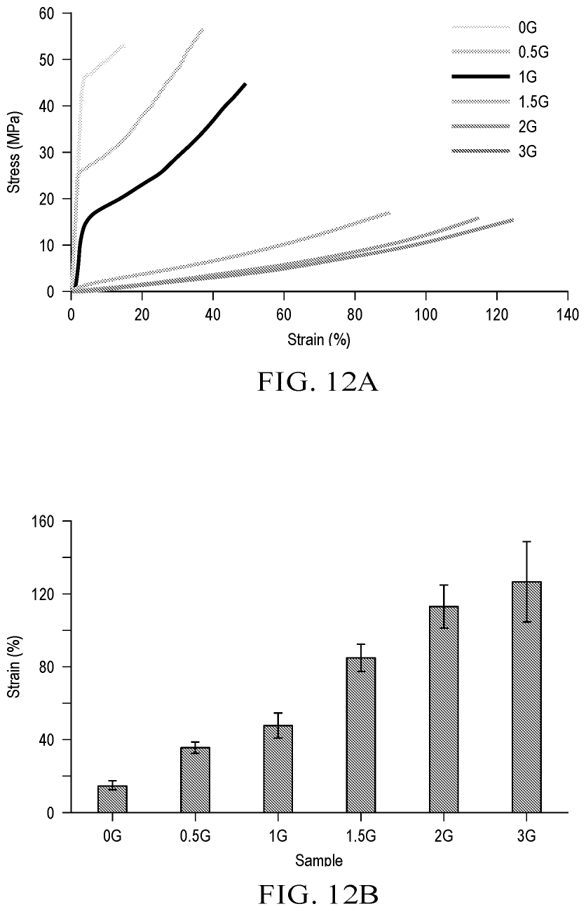

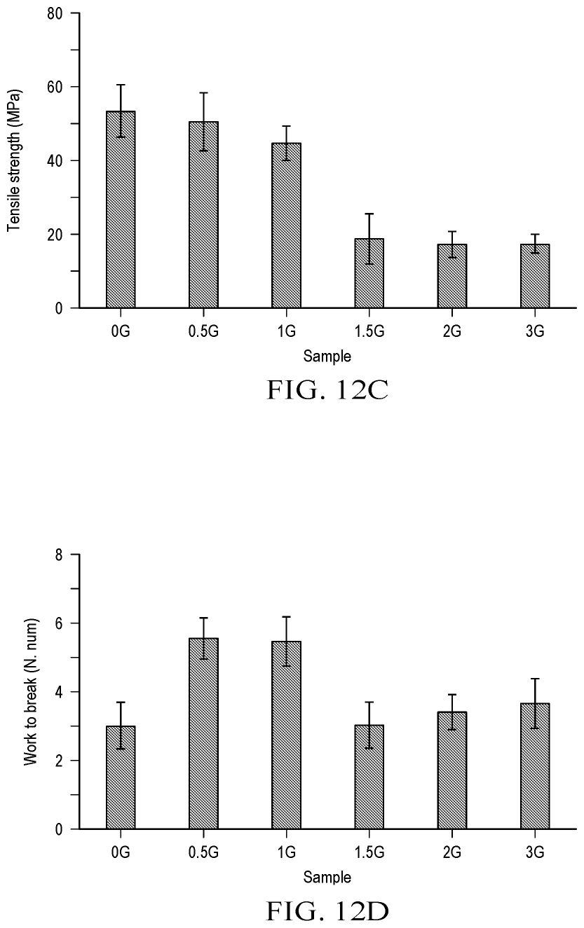

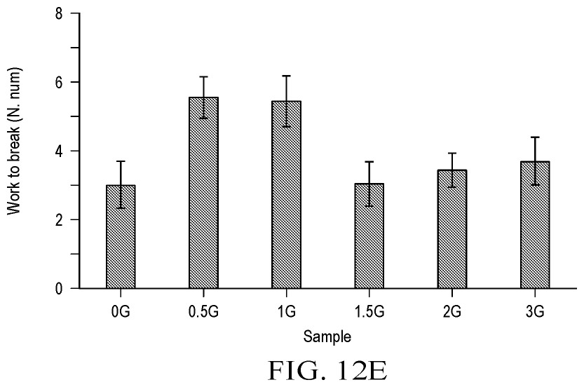

In this example, uniform, thin, flexible, and highly stretchable filaments were prepared by wet spinning guar and guar-cellulose solutions into an acetone-water (1% water, v/v) bath containing varying concentrations of glycerol as a plasticizer (0, 0.5, 1, 1.5, 2, and 3% w/v, named as 0G, 0.5G, 1G, 1.5G, 2G, and 3G, respectively) (FIGS. 11A and 11B). Guar solutions spun directly into an acetone/water bath (0G-control) produced continuous filament, but the filaments became stiff and brittle upon drying. Therefore, 0G control guar filaments produced inconsistent tensile data. The tensile properties of guar filaments that were spun into the acetone-water-glycerol baths showed a great dependency on glycerol concentration in the coagulation bath (FIG. 12A to 12E). Especially, the filaments show excellent elongation and flexibility with the addition of glycerol into the coagulation bath. For example, the filaments spun into coagulation baths with 0 (0G), 1 (1G), 1.5 (1.5G), 2 (2G) and 3% (3G) glycerol show an average percent strain of 14.7±2.4, 35.4±3.3, 47.9±6.7, 84.8±7.5, 113.3±11.9, and 126.7±22.5% (FIG. 12B), and average tensile strength of 53.1±7, 50.4±7.9, 44.7±4.6, 18.816.7, 17.2±3.5, and 17.5±2.3 MPa (FIG. 12C), respectively. The Young's modulus of the filaments that indicates their stiffness ranges between approximately 30 and 5200 MPa (FIG. 12E). In addition to neat guar filaments, guar-cellulose composite filaments could also be spun with 5 and 10% CNC and 5, 10, 20, 30% MCC.

FIGS. 11A and 11B show the preparation of guar or guar-cellulose composite filaments by wet spinning of viscous guar or guar-cellulose solutions to acetone-water bath with varying concentrations of glycerol.

FIG. 12A shows the representative stress vs strain in guar filaments wet spun into water and acetone bath with 0 (0G), 0.5 (0.5G), 1 (1G), 1.5 (1.5G), 2 (2G), and 3% (3G) glycerol. FIGS. 12B, 12C, 12D, and 12E show the average strain, tensile strength, work to break, and Young's modulus of guar filaments wet spun to acetone-water bath with varying concentrations of glycerol, respectively.

Guar and guar-cellulose composite aerogels. Polysaccharide-based three-dimensional porous material represents a highly interesting area in material science. They are characterized by biocompatibility, lightweight, high porosity, high specific surface area, and also thermal insulating properties. The polysaccharide-based porous materials can be functionalized with a vast number of functional materials and functionalization techniques. A few studies have reported the production of guar and guar-based composite aerogels as reported in Table 3. In addition, researchers developed guar-based composite hydrogels and self-healing composite gels targeting food, biomedical, pharmaceutical/drug delivery, cosmetics, sensors/actuators, electronics, and coating applications. These hydrogels can be converted to aerogels by removing the liquid phase while maintaining the porous three-dimensional structure usually by freezing followed by freeze-drying or solvent exchange followed by supercritical drying.

In addition to GG, other sources of galactomannans, such as fenugreek, have been used to produce water-insoluble aerogel via Laccase/TEMPO mediated oxidation followed by lyophilization of aqueous gum solutions that might represent a versatile delivery system for food and non-food applications and delivery system for microbiocides.

TABLE 3
Preparation of guar-based porous materials and their targeted applications.

| Nr. | Raw material | Preparation method | Targeted applications | Ref. |
|---|---|---|---|---|
| 1 | Collagen, GG | Aqueous collagen-GG solutions | Hydrogels for biomedical | [30] |
| | | with different GG mass ratios were | applications | |
| | | frozen using liquid nitrogen and | | |
| | | lyophilized to get sponge-like | | |
| | | material. | | |
| 2 | Acrylamide, GG | In situ grafting polymerization and | pH sensitive | [31] |
| | | crosslinking of acrylamide on the | superabsorbent hydrogel | |
| | | GG in aqueous solution to form a | for soil conditioners and | |
| | | gel which was dried either by air or | carriers | |
| | | methanol. | | |
| 3 | Pectin, alginate, GG, | Gelation of polysaccharide aqueous | Insulating materials | [32] |
| | xanthan gum | solutions in molds by direct | | |
| | | immersion in absolute ethanol and | | |
| | | immediately transferring to | | |
| | | autoclave and subjected to | | |
| | | supercritical carbon dioxide drying. | | |
| 4 | GG, tamarind seed | 1% w/v GG and XG were | Food and packaging | [33] |
| | galactoxyloglucan | enzymatically oxidized, frozen, and | | |
| | (XG) | lyophilized. | | |
| 5 | GG, XG | Aqueous GG and XG solutions and | Water absorbents, food | [34] |
| | | GG and XG solutions dispersed | packaging, delivery | |
| | | with nanofibrillated cellulose (5, 15, | systems, tissue | |
| | | and 25% of the weight of the | engineering scaffolds, | |
| | | polysaccharides) were | and encapsulation of | |
| | | enzymatically oxidized, frozen, and | active components | |
| | | lyophilized. | | |
| 6 | GG, acrylamide | GG polyacrylate hydrogel was | Carriers for agro related | [35] |
| | | formed by free radical grafting | materials such as | |
| | | polymerization which was dried in a | Fertilizers, pesticides and | |
| | | hot air oven. | agriculturally important | |
| | | | microbes | |
| 7 | Guar galactomannan | GM, reinforced with 25 wt. % NFC, | Food and other life | [36] |
| | (GM), nanofibrillated | was crosslinked by enzymatic | science applications | |
| | cellulose (NFC) | oxidation followed by stepwise | | |
| | | solvent exchange and supercritical | | |
| | | drying. | | |
| 8 | GG, high-methoxyl | Alcohol-induced gelation (ethanol | Insulating materials | [37] |
| | pectin, low-methoxyl | or methanol) of aqueous | | |
| | pectin, alginate, | polysaccharide solutions and | | |
| | xanthan | supercritical drying. | | |
| 9 | GM from fenugreek, | Laccase/TEMPO-oxidation of | Delivery systems for | [38] |
| | sesbania, guar | aqueous GM solutions, freezing, and | biomedical and industrial | |
| | | lyophilization. | applications | |
| 10 | GM from fenugreek, | Laccase/TEMPO-oxidation of | Delivery systems with | [39] |
| | sesbania, guar | aqueous GM solutions, freezing, and | tunable properties | |
| | | lyophilization. | (uptake, release and | |
| | | | stability) | |
| 11 | GM from fenugreek, | Laccase/TEMPO-oxidation of | Delivery systems for | [40] |
| | sesbania, guar | aqueous GM solutions, freezing, and | active compounds | |
| | | lyophilization. | | |
| 12 | GG, Borax | Borate crosslinked guar carbon | Water splitting and | [41] |
| | | aerogels were prepared by mixing | designing high- | |
| | | GG aqueous solution with borate, | performance carbon- | |
| | | freeze drying, followed by | based electrocatalysts for | |
| | | carbonization. | energy-related | |
| | | | applications | |

Provided herein is a technology related to the development of guar-based porous material or aerogels. The resulting aerogels are lightweight, porous, and have tunable compressibility, size, and shape. Compared to reported literature that targets delivery systems, insulators, tissue engineering, superabsorbents, and carries of active ingredients, the present inventors sought to use them as packaging peanuts that are commonly produced from synthetic polymers or starch.

### Example 4: Preparation of Guar and Guar-Cellulose Composite Aerogels

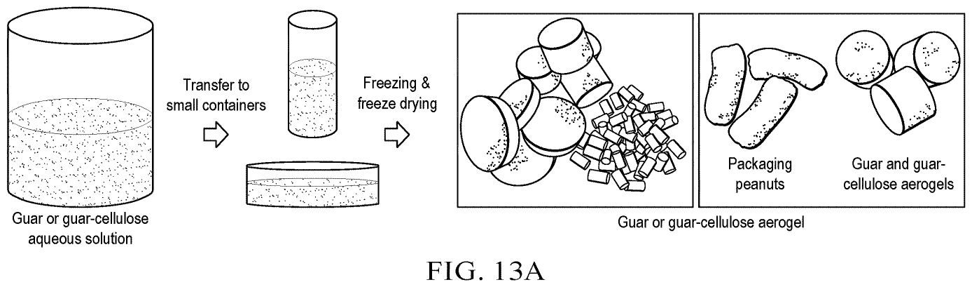

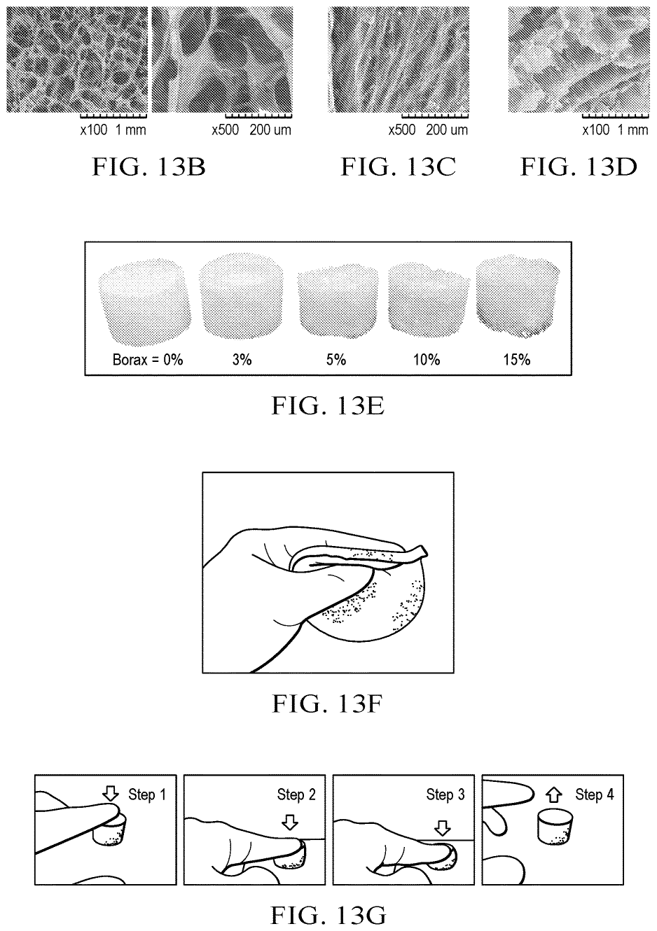

1.5% w/v guar, guar-CNC, and guar-MCC (5 and 10% w/w based on the weight of guar gum) solutions were prepared following the protocol mentioned above. The gel-like guar-based solutions were transferred to plastic vials of different shapes, frozen at −20° C., and subsequently freeze-dried for approximately 40 h depending on the size of the frozen sample (FIGS. 13A to 13G). Guar and guar-cellulose solutions produced whitish, porous (porosity=~99%), and lightweight materials. At 1.5% w/v guar concentration, the resulting aerogels were firm to touch and the addition of CNC and MCC made them harder.

Guar is a water-soluble polymer and therefore, the physicochemical properties of the aerogels could get affected depending on the relative humidity. Thus, the water sensitivity of guar aerogels was simply suppressed by using borax, a common crosslinker used for GG in industrial settings, which prevented the shrinkage and stickiness of guar aerogels in highly humid environments and delayed the water solubility. Borax solution was added to the 1.5% w/v guar gel at 3% and 5% concentrations, and a further increase in borax concentration is not recommended as it could produce a self-standing gel that does not take the shape of the mold. At 1.5% w/v guar concentration, the aerogels crosslinked with 3% borax show a better appearance compared to that of 5% borax. At lower guar concentrations (0.75% w/v), the borax concentration could be increased to 15% without a major effect on the aerogel structures (FIG. 13E). Both neat and crosslinked guar aerogels maintained their properties for months if stored in dry/low moisture conditions at room or lower temperatures.

From FIGS. 13B-13D, it is obvious that the pore structures and size of guar-based aerogels change with the method of freezing as well as the incorporation of borax as a crosslinker. The microscopic structure of borax crosslinked guar aerogels shows clear vertical capillaries divided into small compartments with thin horizontal walls (FIG. 13D), which resemble the structure of chemo-enzymatically oxidized fenugreek galactomannan aerogels [42], oxidized guar galactomannan [33], and composite aerogels made with oxidized tamarind seed galactoxyloglucan and 20% nanofibrilated cellulose [34]. The neat GG aerogels, which were frozen at −20° C. show interconnected pore structures but do not reveal pronounced vertical capillaries and show similarities to that of GM aerogels prepared from the endosperm of sesbania (FIG. 13B). The porous structures of neat GG aerogels, which were frozen using liquid nitrogen show fibrous structures, and they were completely different from aerogels produced by freezing them at −20° C. (FIG. 13C).

The compressive moduli of galactomannan aerogels show great dependency on the oxidation, polysaccharide type, freezing method, and moisture level in the environment [33]. In the present study, the inventors produced compressible and non-compressible guar-based aerogels by simply changing the concentration of GG in the original solution. Low concentrations of GG make foldable (FIG. 13F) and compressible aerogels (0.75 or 1% w/v guar solutions) (FIG. 13G) while high concentrations of GG (≥1.5% w/v) make them less compressible. In addition, the incorporation of borax, even in very small concentrations, makes them rigid and non-compressible (1% w/w based on the weight of guar gum).

Due to the high surface area, porosity, and lightweight of guar and guar-cellulose porous materials, guar-based aerogels should find many industrial applications, especially in the pharmaceutical industry and as an ideal material for adsorption experiments. Targeted applications of guar-based materials are delivery systems, insulators, tissue engineering, superabsorbents, and carriers of active ingredients (Table 3).

It was found that both crosslinked and non-crosslinked guar and guar-cellulose solutions produced high-quality porous and lightweight materials. They can also be mixed with other functional materials/active ingredients to develop porous material for different targeted applications (e.g., quantum dots, carbon nanotubes, graphene oxide). The shape and size of these materials can be modified by simply changing the shape of the molds. In addition, these materials resemble “packaging peanuts” or polystyrene foam (FIG. 13A). Therefore, these aerogels can be used as a safe substitute for packaging peanuts, especially for food packaging.

It has been reported that the oxidization of galactomannans makes galactomannan-based aerogels water-insoluble [33], [39], [40]. However, the products prepared herein are water-soluble, and therefore, after use, they could be repurposed/reshaped into different bioproducts by simply dissolving in water followed by casting, wet spinning, freeze drying, or even by 3D printing.

FIGS. 13A to 13G shows the preparation of guar-based porous materials. (FIG. 13A) Preparation steps of guar-based aerogels and produced aerogels of different shapes and sizes. Scanning electron microscopy micrographs of (FIG. 13B) neat guar aerogels frozen at −20° C., (FIG. 13C) neat guar aerogels frozen using liquid nitrogen, and (FIG. 13D) borax crosslinked guar aerogel frozen at −20° C. (FIG. 13E) Borax crosslinked guar aerogels. (FIG. 13F) Foldable and (FIG. 13G) compressible guar aerogels made with low concentrations of guar gum.

### Example 5: Preparation of Guar and Guar-Cellulose Composite Aerogels

In general, cellulose-based porous materials are made by dissolving cellulose in a NaOH aqueous solution followed by gelation, regeneration in water, solvent exchange with acetone, and supercritical CO₂ drying. However, the use of guar as a binder provides a simple, wastewater-free, and chemical-free approach to produce cellulose-based porous materials. To the best of the inventors' knowledge, guar has not been used as a binder to produce cellulose-based porous materials using a simple approach of water dispersion followed by freeze-drying.

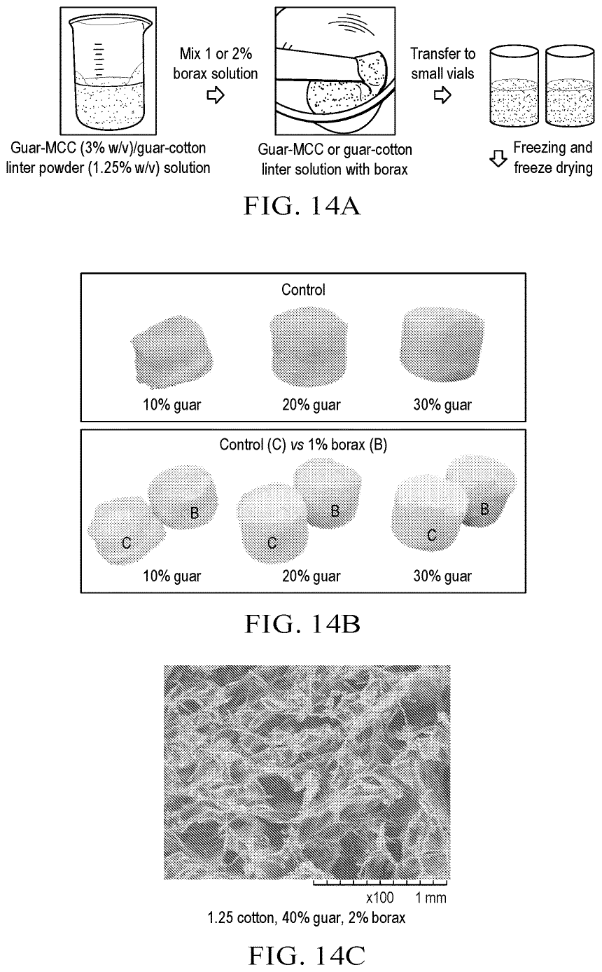

Similar to making cotton linter-guar films, purified cotton linters were ground to 40 mesh size using a laboratory mill and soaked in water overnight (1.25% w/v). Then, the linter powder was ultrasonicated for 15 min and 30 and 40% GG (w/w based on the weight of cotton liter) was dispersed to make a viscous solution. Cotton linter and guar mixture was magnetically stirred for 6 h and 2% of borax (w/w based on the dry weight of the solution) was added to the solution with vigorous stirring with a glass rod and allowed to gelate for 24 h. Cotton linter-guar solution without borax was used as the control. Ten grams (10 g) of the solution was transferred to plastic vials, frozen at −20° C., and freeze-dried for approximately 40 h. A similar experiment was conducted with 3% (w/v) MCC solution. MCC solution with 30% guar (w/w based on the dry weight of MCC) produced nice aerogels, and the aerogels made with 10 and 20% guar showed settling down of MCC in the bottom of aerogels (FIG. 14A to 14C). The aerogels made with 10% guar are soft and fragile indicating that the solution is not viscous enough to keep MCC suspended in the solution. Increasing the guar concentration and/or mild crosslinking with borax (1% borax for 3% w/v MCC and 2% borax for 1.25% cotton linter) helped improve the dispersion of cotton linters in the solution and improved the overall quality of the aerogels.

FIGS. 14A to 14C show guar-cellulose (microcrystalline cellulose/cotton linter powder) composite aerogels. (FIG. 14A) Preparation steps of guar-cellulose composite aerogels. (FIG. 14B) effect of guar concentration and crosslinking on guar-3% MCC composite aerogels. (FIG. 14C) Scanning electron microscopy micrograph of aerogels made with 1.25% cotton linter powder, 40% guar (w/w based on the weight of cellulose) and 2% borax.

It is contemplated that any embodiment discussed in this specification can be implemented with respect to any method, kit, reagent, or composition of the invention, and vice versa. Furthermore, compositions of the invention can be used to achieve methods of the invention.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps. In embodiments of any of the compositions and methods provided herein, “comprising” may be replaced with “consisting essentially of” or “consisting of”. As used herein, the phrase “consisting essentially of” requires the specified integer(s) or steps as well as those that do not materially affect the character or function of the claimed invention. As used herein, the term “consisting” is used to indicate the presence of the recited integer (e.g., a feature, an element, a characteristic, a property, a method/process step or a limitation) or group of integers (e.g., feature(s), element(s), characteristic(s), propertie(s), method/process steps or limitation(s)) only.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

As used herein, words of approximation such as, without limitation, “about”, “substantial” or “substantially” refers to a condition that when so modified is understood to not necessarily be absolute or perfect but would be considered close enough to those of ordinary skill in the art to warrant designating the condition as being present. The extent to which the description may vary will depend on how great a change can be instituted and still have one of ordinary skilled in the art recognize the modified feature as still having the required characteristics and capabilities of the unmodified feature. In general, but subject to the preceding discussion, a numerical value herein that is modified by a word of approximation such as “about” may vary from the stated value by at least ±1, 2, 3, 4, 5, 6, 7, 10, 12 or 15%.

Additionally, the section headings herein are provided for consistency with the suggestions under 37 CFR 1.77 or otherwise to provide organizational cues. These headings shall not limit or characterize the invention(s) set out in any claims that may issue from this disclosure. Specifically and by way of example, although the headings refer to a “Field of Invention,” such claims should not be limited by the language under this heading to describe the so-called technical field. Further, a description of technology in the “Background of the Invention” section is not to be construed as an admission that technology is prior art to any invention(s) in this disclosure. Neither is the “Summary” to be considered a characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings set forth herein.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

To aid the Patent Office, and any readers of any patent issued on this application in interpreting the claims appended hereto, applicants wish to note that they do not intend any of the appended claims to invoke paragraph 6 of 35 U.S.C. § 112, U.S.C. § 112 paragraph (f), or equivalent, as it exists on the date of filing hereof unless the words “means for” or “step for” are explicitly used in the particular claim.

For each of the claims, each dependent claim can depend both from the independent claim and from each of the prior dependent claims for each and every claim so long as the prior claim provides a proper antecedent basis for a claim term or element.

### REFERENCES

[1] Y. A. Arfat, M. Ejaz, H. Jacob, and J. Ahmed, “Deciphering the potential of guar gum/Ag—Cu nanocomposite films as an active food packaging material,” Carbohydr. Polym., vol. 157, pp. 65-71, February 2017, doi: 10.1016/j.carbpol.2016.09.069.
[2] M. S. Rao, S. R. Kanatt, S. P. Chawla, and A. Sharma, “Chitosan and guar gum composite films: Preparation, physical, mechanical and antimicrobial properties,” Carbohydr. Polym., vol. 82, no. 4, pp. 1243-1247 Novmber 2010, doi: 10.1016/j.carbpol.2010.06.058.
[3] V. S. Karande, A. K. Bharimalla, N. Vigneshwaran, P. G. Kadam, and S. T. Mhaske, “Cotton linter nano-fibers as the potential reinforcing agent for guar gum,” Iran. Polym. J., vol. 23, no. 11, pp. 869-879, November 2014, doi: 10.1007/s13726-014-0283-2.
[4] C. K. Saurabh, S. Gupta, J. Bahadur, S. Mazumder, P. S. Variyar, and A. Sharma, “Mechanical and barrier properties of guar gum based nano-composite films,” Carbohydr. Polym., vol. 124, pp. 77-84, June 2015, doi: 10.1016/j.carbpol.2015.02.004.
[5] L. Dai, Z. Long, Y. Zhao, B. Wang, and J. Chen, “Comparison of hydroxypropyl and carboxymethyl guar for the preparation of nanocellulose composite films,” Cellulose, vol. 23, no. 5, pp. 2989-2999 October 2016, doi: 10.1007/s10570-016-0998-7.
[6] P. Savvashe, P. Kadam, and S. Mhaske, “Effect of nano-alumina concentration on the mechanical, rheological, barrier and morphological properties of guar gum,” J. Food Sci. Technol., vol. 53, no. 4, pp. 1948-1956 April 2016, doi: 10.1007/s13197-015-2114-7.
[7] Y. Tang, X. Zhang, R. Zhao, D. Guo, and J. Zhang, “Preparation and properties of chitosan/guar gum/nanocrystalline cellulose nanocomposite films,” Carbohydr. Polym., vol. 197, no. January, pp. 128-136, October 2018, doi: 10.1016/j.carbpol.2018.05.073.
[8] Y. Hu and N. Abidi, “Distinct Chiral Nematic Self-Assembling Behavior Caused by Different Size-Unified Cellulose Nanocrystals via a Multistage Separation,” Langmuir, vol. 32, no. 38, pp. 9863-9872 September 2016, doi: 10.1021/acs.langmuir.6b02861.
[9] K. Prasad, H. Izawa, Y. Kaneko, and J. Kadokawa, “Preparation of temperature-induced shapeable film material from guar gum-based gel with an ionic liquid,” J. Mater. Chem., vol. 19, no. 24, pp. 4088-4090, 2009, doi: 10.1039/b903332g.
[10] J. Kadokawa, T. Kato, M. Setoyama, and K. Yamamoto, “Preparation of Galactomannan-Based Materials Compatibilized with Ionic Liquids,” J. Polym. Environ., vol. 21, no. 2, pp. 512-519, June 2013, doi: 10.1007/s10924-012-0495-5.
[11] P. Myllytie, L. Salmen, E. Haimi, and J. Laine, “Viscoelasticity and water plasticization of polymer-cellulose composite films and paper sheets,” Cellulose, vol. 17, no. 2, pp. 375-385, April 2010, doi: 10.1007/s10570-009-9376-z.
[12] W. Xiao and L. Dong, “Novel excellent property film prepared from methacryloyl chloride-graft-guar gum matrixes,” 2011 Int. Conf. Consum. Electron. Commun. Networks, CECNet 2011-Proc., pp. 1442-1445 April 2011, doi: 10.1109/CECNET.2011.5768424.
[13] R. S. Banegas et al., “Preparation, characterization and properties of films obtained from cross-linked guar gum,” Polimeros, vol. 23, no. 2, pp. 182-188, 2013, doi: 10.4322/polimeros.2013.082.
[14] K. S. Mikkonen, H. Rita, H. Helen, R. A. Talja, L. Hyvonen, and M. Tenkanen, “Effect of Polysaccharide Structure on Mechanical and Thermal Properties of Galactomannan-Based Films,” Biomacromolecules, vol. 8, no. 10, pp. 3198-325 October 2007, doi: 10.1021/bm700538c.
[15] M. F. Abdullah, S. K. Ghosh, S. Basu, and A. Mukherjee, “Cationic guar gum orchestrated environmental synthesis for silver nano-bio-composite films,” Carbohydr. Polym., vol. 134, pp. 30-37, December 2015, doi: 10.1016/j.carbpol.2015.06.029.
[16] C. Sui, W. Zhang, F. Ye, X. Liu, and G. Yu, “Preparation, physical, and mechanical properties of soy protein isolate/guar gum composite films prepared by solution casting,” J. Appl. Polym. Sci., vol. 133, no. 18, p. 43382 (1 of 9), May 2016, doi: 10.1002/app.43382.
[17] L. Dai et al., “Robust Guar Gum/Cellulose Nanofibrils Multilayer Films with Good Barrier Properties,” ACS Appl. Mater. Interfaces, vol. 9, no. 6, pp. 5477-5485 February 2017, doi: 10.1021/acsami.6b14471.
[18] S. Nandi and P. Guha, “Modelling the effect of guar gum on physical, optical, barrier and mechanical properties of potato starch based composite film,” Carbohydr. Polym., vol. 200, no. August, pp. 498-507, November 2018, doi: 10.1016/j.carbpol.2018.08.028.
[19] J. Lucenius, J. J. Valle-Delgado, K. Parikka, and M. Österberg, “Understanding hemicellulose-cellulose interactions in cellulose nanofibril-based composites,” J. Colloid Interface Sci., vol. 555, pp. 104-114, November 2019, doi: 10.1016/j.jcis.2019.07.053.
[20] C. Vilas Dhumal, K. Pal, and P. Sarkar, “Synthesis, characterization, and antimicrobial efficacy of composite films from guar gum/sago starch/whey protein isolate loaded with carvacrol, citral and carvacrol-citral mixture,” J. Mater. Sci. Mater. Med., vol. 30, no. 10, p. 117, October 2019, doi: 10.1007/s10856-019-6317-8.
[21] J. Tripathi, R. Ambolikar, S. Gupta, D. Jain, J. Bahadur, and P. S. Variyar, “Methylation of guar gum for improving mechanical and barrier properties of biodegradable packaging films,” Sci. Rep., vol. 9, no. 1, p. 14505, October 2019, doi: 10.1038/s41598-019-50991-7.
[22] D. Jussen, S. Sharma, J. K. Carson, and K. L. Pickering, “Preparation and tensile properties of guar gum hydrogel films,” Polym. Polym. Compos., vol. 28, no. 3, pp. 180-186, March 2020, doi: 10.1177/0967391119867560.
[23] M. Alizadeh-Sani, J.-W. W. Rhim, M. Azizi-Lalabadi, M. Hemmati-Dinarvand, and A. Ehsani, “Preparation and characterization of functional sodium caseinate/guar gum/TiO2/cumin essential oil composite film,” Int. J. Biol. Macromol., vol. 145, pp. 835-844, February 2020, doi: 10.1016/j.ijbiomac.2019.11.004.
[24] M. Österberg et al., “A Fast Method to Produce Strong NFC Films as a Platform for Barrier and Functional Materials,” ACS Appl. Mater. Interfaces, vol. 5, no. 11, pp. 4640-4647 June 2013, doi: 10.1021/am401046x.
[25] M. J. Lundahl et al., “Absorbent Filaments from Cellulose Nanofibril Hydrogels through Continuous Coaxial Wet Spinning,” ACS Appl. Mater. Interfaces, vol. 10, no. 32, pp. 27287-27296, 2018, doi: 10.1021/acsami.8b08153.
[26] M. J. Lundahl, M. Berta, M. Ago, M. Stading, and O. J. Rojas, “Shear and extensional rheology of aqueous suspensions of cellulose nanofibrils for biopolymer-assisted filament spinning,” Eur. Polym. J., vol. 109, no. August, pp. 367-378, 2018, doi: 10.1016/j.eurpolymj.2018.10.006.
[27] A. F. Lubambo et al., “Electrospinning of commercial guar-gum: Effects of purification and filtration,” Carbohydr. Polym., vol. 93, no. 2, pp. 484-491, 2013, doi: 10.1016/j.carbpol.2013.01.031.
[28] L. Shu Liu, W. Yang, A. MM Sousa, X. Li, and P. M Tomasula, “Electrospinning of Guar Gum/Corn Starch Blends,” SOJ Mater. Sci. Eng., vol. 5, no. 1, pp. 1-7, 2017, doi: 10.15226/sojmse.2017.00142.
[29] T. Pirzada, B. V. D. Farias, H. M. A. Chu, and S. A. Khan, “Fabrication of Guar-Only Electrospun Nanofibers by Exploiting a High- and Low-Molecular Weight Blend,” ACS Omega, vol. 4, no. 6, pp. 10767-10774, 2019, doi: 10.1021/acsomega.9b00902.
[30] R. Manikoth, I. Kanungo, N. N. Fathima, and J. R. Rao, “Dielectric behaviour and pore size distribution of collagen-guar gum composites: Effect of guar gum,” Carbohydr. Polym., vol. 88, no. 2, pp. 628-637, April 2012, doi: 10.1016/j.carbpol.2012.01.031.
[31] K. S. V. P. Chandrika, A. Singh, D. J. Sarkar, A. Rathore, and A. Kumar, “PH-sensitive crosslinked guar gum-based superabsorbent hydrogels: Swelling response in simulated environments and water retention behavior in plant growth media,” J. Appl. Polym. Sci., vol. 131, no. 22, pp. 1-12, 2014, doi: 10.1002/app.41060.
[32] G. Tkalec, Ž. Knez, and Z. Novak, “Formation of polysaccharide aerogels in ethanol,” RSC Adv., vol. 5, no. 94, pp. 77362-77371, 2015, doi: 10.1039/c5ra14140k.
[33] K. S. Mikkonen, K. Parikka, J. P. Suuronen, A. Ghafar, R. Serimaa, and M. Tenkanen, “Enzymatic oxidation as a potential new route to produce polysaccharide aerogels,” RSC Adv., vol. 4, no. 23, pp. 11884-11892, 2014, doi: 10.1039/c3ra47440b.
[34] A. Ghafar, K. Parikka, T. Sontag-Strohm, M. Österberg, M. Tenkanen, and K. S. Mikkonen, “Strengthening effect of nanofibrillated cellulose is dependent on enzymatically oxidized polysaccharide gel matrices,” Eur. Polym. J., vol. 71, pp. 171-184, 2015, doi: 10.1016/j.eurpolymj.2015.07.046.
[35] K. P. Chandrika, A. Singh, A. Rathore, and A. Kumar, “Novel cross linked guar gum-g-poly(acrylate) porous superabsorbent hydrogels: Characterization and swelling behaviour in different environments,” Carbohydr. Polym., vol. 149, pp. 175-185, 2016, doi: 10.1016/j.carbpol.2016.04.077.
[36] A. Ghafar et al., “Mesoporous guar galactomannan based biocomposite aerogels through enzymatic crosslinking,” Compos. Part A Appl. Sci. Manuf., vol. 94, pp. 93-103, March 2017, doi: 10.1016/j.compositesa.2016.12.013.
[37] G. Horvat, T. Fajfar, A. Perva Uzunalić, Ž. Knez, and Z. Novak, “Thermal properties of polysaccharide aerogels,” J. Therm. Anal. calorim., vol. 127, no. 1, pp. 363-370, 2017, doi: 10.1007/s10973-016-5814-y.
[38] P. Campia et al., “′Aerogels of enzymatically oxidized galactomannans from leguminous plants: Versatile delivery systems of antimicrobial peptides and enzymes,” Carbohydr. Polym., vol. 158, pp. 102-111, 2017, doi: 10.1016/j.carbpol.2016.11.089.
[39] E. Ponzini et al., “Structural characterization of aerogels derived from enzymatically oxidized galactomannans of fenugreek, sesbania and guar gums,” Carbohydr. Polym., vol. 207, no. November 2018, pp. 510-520, 2019, doi: 10.1016/j.carbpol.2018.11.100.
[40] B. Rossi, E. Ponzini, L. Merlini, R. Grandori, and Y. M. Galante, “Characterization of aerogels from chemo-enzymatically oxidized galactomannans as novel polymeric biomaterials,” Eur. Polym. J., vol. 93, no. April, pp. 347-357, 2017, doi: 10.1016/j.eurpolymj.2017.06.016.
[41] Y. Cheng et al., “Borate crosslinking synthesis of structure tailored carbon-based bifunctional electrocatalysts directly from guar gum hydrogels for efficient overall water splitting,” Carbon N. Y., vol. 157, pp. 153-163, 2020, doi: 10.1016/j.carbon.2019.10.024.
[42] B. Rossi et al., “An aerogel obtained from chemo-enzymatically oxidized fenugreek galactomannans as a versatile delivery system,” Carbohydr. Polym., vol. 144, pp. 353-361, 2016, doi: 10.1016/j.carbpol.2016.02.007.
[43] Z. Ling et al., “Actuating, shape reconstruction, and reinforcement of galactomannan-based hydrogels by coordination bonds induced metal ions capture,” Int. J. Biol. Macromol., vol. 165, pp. 2721-2730, 2020, doi: 10.1016/j.ijbiomac.2020.10.059.

What is claimed is:

1. A guar-based composite material comprising:
a guar gum comprising 1, 2, 5, 10, 15, 20, 25, 30, 35, 40, or 50% weight to weight of the composite;
a cellulose comprising 1, 2, 5, 10, 15, 20, 25, 30, 35, 40, or 50% weight to weight of the composite; and
optionally a plasticizer, a crosslinker, or both, wherein the composite has a higher flexibility and tensile strength than either the guar gum or cellulose alone.

2. The composite of claim 1, wherein the composite is a film, aerogel, or filament.

3. The composite of claim 1, wherein the plasticizer is glycerol.

4. The composite of claim 1, wherein the cellulose is at least one of: natural cellulose, microcrystalline cellulose, nanocrystalline cellulose, never dissolved cellulose, methyl cellulose, ethyl cellulose, hydroxyethyl cellulose, hydroxypropyl cellulose, hydroxypropylmethyl cellulose, carboxymethyl cellulose, or cellulose derivatives.

5. The composite of claim 1, wherein the composite is a film comprising at least one of:
guar-cellulose films exhibiting smooth surface texture, strain up to about 80% depending on the plasticizer content, tensile strength up to about 95 MPa depending on the type and quantity of cellulose, and smart rolling behavior when exposed to water, alcohol, or acetone.

6. The composite of claim 1, wherein the composite is at least one of:
a film with higher flexibility, elongation, and tensile strength than guar or cellulose alone;
a filament having at least one of: an elongation of up to 180% or a tensile strength of 10, 20, 30, 40, 50, or up to 60 MPa;
an aerogel having a porosity of 80, 86, 90, 95, or 99%; or
the composite can be dissolved in water and reshaped.

7. The composite of claim 1, wherein the guar gum comprises 1, 2, 5, 10, 15, 20, 25, 30, 35, 40, or 50% weight to weight of the composite.

8. The composite of claim 1, wherein the cellulose comprises 1, 2, 5, 10, 15, 20, 25, 30, 35, 40, or 50% weight to weight of the composite.

9. A method of preparing a composite comprising:
mixing guar gum and cellulose in an aqueous solution into a guar-cellulose mixture;
casting guar-cellulose mixture in a mold;
drying or freezing the cast guar-cellulose mixture; and
freeze-drying the frozen guar-cellulose mixture.

10. The method of claim 9, wherein the composite is a film, aerogel, or filament.

11. The method of claim 9, further comprising adding a plasticizer or a crosslinker, or both.

12. The method of claim 9, wherein the cellulose is at least one of: natural cellulose, microcrystalline cellulose, nanocrystalline cellulose, never dissolved cellulose, methyl cellulose, ethyl cellulose, hydroxyethyl cellulose, hydroxypropyl cellulose, hydroxypropylmethyl cellulose, carboxymethyl cellulose, or cellulose derivatives.

13. The method of claim 9, wherein the composite is a film comprising at least one of: guar-cellulose films exhibiting smooth surface texture, strain up to about 80% depending on the plasticizer content, tensile strength up to about 95 MPa depending on the type and quantity of cellulose, and smart rolling behavior when exposed to water, alcohol, or acetone.

14. The method of claim 9, wherein the composite is at least one of:
a film with higher flexibility, elongation, and tensile strength than guar or cellulose alone;
a filament having an elongation of up to 180% and a tensile strength of 10, 20, 30, 40, 50, or up to 60 MPa;
an aerogel having a porosity of 80, 85, 90, 95, or 99%; or
can be dissolved in water and reshaped.

15. The method of claim 9, wherein the guar comprises 1, 2, 5, 10, 15, 20, 25, 30, 35, 40, or 50% weight to weight of the composite.

16. The method of claim 9, wherein the cellulose comprises 1, 2, 5, 10, 15, 20, 25, 30, 35, 40, or 50% weight to weight of the composite.

17. The method of claim 9, further comprising wet spinning the guar-cellulose mixture into an acetone-based bath with varying concentrations of a plasticizer to form a filament.

18. The method of claim 9, wherein the guar gum is gelled in an ionic liquid and the gelled guar gum is regenerated in an organic solvent.

19. The method of claim 9, wherein the guar-cellulose mixture is mixed with borax to transform never dissolved cotton fibers into flexible paper-like films, wherein the flexible paper-like films are formed without harsh solvents or generating a waste water with chemical residues.

20. A film, aerogel, or filament comprising:
a guar gum comprising 1, 2, 5, 10, 15, 20, 25, 30, 35, 40, or 50% weight to weight of the composite;
a cellulose comprising 1, 2, 5, 10, 15, 20, 25, 30, 35, 40, or 50% weight to weight of the composite; and
optionally a plasticizer, a crosslinker, or both, wherein the composite has a higher flexibility and tensile strength than either the guar gum or cellulose alone.
